(19) United States
(12) Patent Application Publication
(10) Pub. No.: US 2016/0132948 A1
(43) Pub. Date: May 12, 2016

(54) SYSTEM AND METHOD FOR ONLINE MARKETPLACE FOR SERVICES

(71) Applicant: ServiceWhale Inc., Princeton, NJ (US)

(72) Inventors: Dmitri Saveliev, Princeton, NJ (US); Oleg Ivanov, Holland, PA (US)

(21) Appl. No.: 14/937,163

(22) Filed: Nov. 10, 2015

Related U.S. Application Data
(60) Provisional application No. 62/077,422, filed on Nov. 10, 2014.

(51) Int. Cl. G06Q 30/06; G06Q 10/08

(52) U.S. Cl. CPC G06Q 30/0611; G06Q 10/0875

(57) ABSTRACT

Computer-implemented methods for generating quotes are provided herein. Questions associated with service request parameters of a type of service can be presented. Input indicative of values for the service request parameters can be received. The values for the service request parameters can be associated with a service request. Service listings can be provided upon memory. Each of the service listings can be associated with a service provider, service provider rules for the service provider, and price parameters. The values for the service request parameters can be compared with the service provider rules. The service request can be matched to matching listings of the service listings based upon the service request parameters and the service provider rules that are compared. Quotes for the matching listings of the service listings can be generated. The quotes can be calculated using the price parameters associated with the matching listings of the service listings.

### CROSS-REFERENCE TO RELATED APPLICATIONS

This application claims the benefit of U.S. Provisional Application No. 62/077,422, filed Nov. 10, 2014, which is hereby incorporated by reference in its entirety.

### BACKGROUND

Consumers in the market for goods and services benefit when presented with a large number and variety of choices. Generally, a greater selection of goods or services results in the consumer purchasing the desired good or service at a greater value. This is to say that the consumer purchases a product or service that meets all or most of the consumer's requirements at a price acceptable to the consumer.

With regard to goods, consumers can compare a number of similar goods based on price and attributes of the goods. For example, when a consumer desires to purchase a durable good such as a television, the consumer can compare the prices of televisions and attributes of televisions offered for sale. The consumer can review attributes that are important to the consumer such as picture display technology (liquid crystal display, plasma display panel, light emitting diode based displays, etc.), screen size, resolution, input and output connection, audio quality, and so on. Because such attributes for a durable good such as televisions are readily comparable, the task of finding the best value among the consumer's choices is relatively straightforward.

Traditionally, a consumer could visit one or more electronics stores and compare a number of televisions before making a purchase. In addition, over the last fifteen to twenty years, the proliferation of consumer-based commerce conducted over the internet has made the tasks of purchasing a good much more efficient. Today, a consumer browsing for goods on various internet websites can quickly find and compare the prices and attributes of a large number of goods and confidently complete a purchase assured that the purchase constitutes a good value. In the example of televisions, a consumer can use search and filter functionality offered by many consumer websites to compare a large number of models of televisions from a large number of manufacturers. The consumer can quickly narrow the selection of televisions to one or two manufacturers and models that include all the attributes important to the consumer. The consumer can then purchase a television based solely on price. The result is the consumer purchasing a television that meets the consumer's needs at the lowest offered price.

The purchase of services is not nearly as straightforward as the purchase of goods. This is particularly true for services that require that a number of variables be considered before or as the service is rendered. Examples of variables that might need to be considered when providing a service include what parts, tools, equipment, and systems are required to facilitate the service and the number of labor hours and skill level required for the persons performing the service. One example of a service that often includes variables is home remodeling and renovation. Projects such as the replacement of a heating, ventilating, and air conditioning (“HVAC”) system can include a number of variables that are not easily ascertained. For example, the cost of parts and systems required for an HVAC replacement project can depend on the size, layout, and design of the home. The hours required and skill level required to replace an HVAC system can depend on the type and age of the current HVAC system, the location of the HVAC system within and/or outside the home, and electrical and other utility requirements for the HVAC system.

Typically consumers shop for services by contacting a local service provider, meeting with the service provider to discuss the service, and receiving a quote for the service from the service provider. The consumer may repeat this process with an additional one or two service providers. However, because the process is time consuming, the consumer typically does not receive more than a few quotes for providing the service. With a limited number of quotes, it is difficult for the consumer to be confident that the selected service provider will provide the best value for the services provided. The increased use of the internet for commerce has not resulted in improving the efficiencies of purchasing services as it has for the purchase of goods. Typical websites that match consumers with service providers generally only provide leads for service providers or provide reviews and contact information for consumers. Because of the variability of services, the one-to-one comparisons of attributes and instant pricing that are useful when purchasing goods, have not been implemented for the sale of services. The consumer still meets in person with a few service providers and receives manual quotes from the service providers, especially for major services such as home improvement projects.

There is a need for methods and systems that can provide for a consumer to shop for services among a large number of service providers and receive instant quotes for such services in an efficient and timely manner.

### SUMMARY

In one embodiment, a computer-implemented method for generating a plurality of quotes is provided. The method can include executing on one or more processor a plurality of steps. Questions associated with service request parameters of a type of service can be presented. Input indicative of values for the service request parameters can be received. The values for the service request parameters can be associated with a service request. Service listings can be provided upon memory. Each of the service listings can be associated with a service provider, service provider rules for the service provider, and price parameters for the service provider. The values for the service request parameters can be compared with the service provider rules. The service request can be matched to matching listings of the service listings based upon the service request parameters and the service provider rules that are compared. Quotes for the matching listings of the service listings can be generated. The quotes can be calculated using the price parameters associated with the matching listings of the service listings.

In another embodiment, a computer-implemented method for presenting predefined quotes is provided. The method can include executing on one or more processor a plurality of steps. Service listings can be provided upon memory. Each of the service listings can be associated with a service provider, service provider rules for the service provider, and price parameters for the service provider. Standard values for service request parameters for a plurality of service types can be provided. The standard values for the service request parameters can be compared with the service provider rules. Predefined quotes for each of the service types can be generated. The predefined quotes can be calculated using the price parameters associated with the service listings. Quote objects can be presented upon a display. Each of the quote objects can be associated with one of the service types and can provide a visual summary indicative of the predefined quotes of the one of the service types. Input can be received with a selected one of the quote objects. The predefined quotes of the one of the service types associated with the selected one of the quote objects can be presented upon the display.

In a further embodiment, a system for generating quotes upon a webpage can comprise one or more databases and a service provider server. The one or more databases can define one or more service listings. The service listings can be associated with a service provider, service provider rules for the service provider, and price parameters for the service provider. The one or more databases can belong to an online marketplace. The online marketplace and the service provider can be third parties with respect to one another. The service provider server can be controlled by the service provider. The service provider server can be communicatively coupled to the one or more databases and programmed to present a webpage comprising a quote control configured to receive input. Input can be received with the quote control. A quote widget can be launched upon the webpage responsive to the input. Questions associated with service request parameters can be presented with the quote widget. Input indicative of values for the service request parameters can be received with the quote widget. The service provider rule and the price parameters can be accessed. A quote can be presented with the quote widget. The quote can be determined based upon the values for the service request parameters, the service provider rule, and the price parameters.

### BRIEF DESCRIPTION OF THE DRAWINGS

In the accompanying drawings, structures are illustrated that, together with the detailed description provided below, describe example embodiments of the present disclosure. Where appropriate, like elements are identified with the same or similar reference numerals. Elements shown as a single component may be replaced with multiple components. Elements shown as multiple components may be replaced with a single component. The drawings may not be to scale. The proportion of certain elements may be exaggerated for the purpose of illustration.

FIG. 1 is a schematic illustration of a portion of an online marketplace for services in accordance with one or more embodiments shown and described herein.

FIG. 2 is a schematic illustration of server hardware communicatively coupled to client hardware in accordance with one or more embodiments shown and described herein.

FIG. 3 is a schematic illustration of a portion of an online marketplace for services in accordance with one or more embodiments shown and described herein.

FIG. 4 is an exemplary webpage for use with one or more embodiments shown and described herein.

FIG. 5 is an exemplary webpage for use with one or more embodiments shown and described herein.

FIG. 6 is an exemplary webpage for use with one or more embodiments shown and described herein.

FIG. 7 is an exemplary webpage for use with one or more embodiments shown and described herein.

FIG. 8 is an exemplary webpage for use with one or more embodiments shown and described herein.

FIG. 9 is an exemplary webpage for use with one or more embodiments shown and described herein.

FIG. 10 is an exemplary webpage for use with one or more embodiments shown and described herein.

FIG. 11 is an exemplary webpage for use with one or more embodiments shown and described herein.

FIG. 12 is an exemplary webpage for use with one or more embodiments shown and described herein.

FIG. 13 is an exemplary webpage for use with one or more embodiments shown and described herein.

FIG. 14 is an exemplary webpage for use with one or more embodiments shown and described herein.

FIG. 15 is an exemplary webpage for use with one or more embodiments shown and described herein.

FIG. 16 is an exemplary webpage for use with one or more embodiments shown and described herein.

FIG. 17 is an exemplary webpage for use with one or more embodiments shown and described herein.

FIG. 18 is an exemplary webpage for use with one or more embodiments shown and described herein.

FIGS. 19A and 19B depict partial views of the exemplary webpage of FIG. 18 for use with one or more embodiments shown and described herein.

FIG. 20 is an exemplary webpage for use with one or more embodiments shown and described herein.

FIG. 21 is an exemplary webpage for use with one or more embodiments shown and described herein.

FIG. 22 is an exemplary webpage for use with one or more embodiments shown and described herein.

FIG. 23 is an exemplary webpage for use with one or more embodiments shown and described herein.

FIG. 24 is an exemplary webpage for use with one or more embodiments shown and described herein.

FIG. 25 is an exemplary webpage for use with one or more embodiments shown and described herein.

FIG. 26 is an exemplary webpage for use with one or more embodiments shown and described herein.

### DETAILED DESCRIPTION

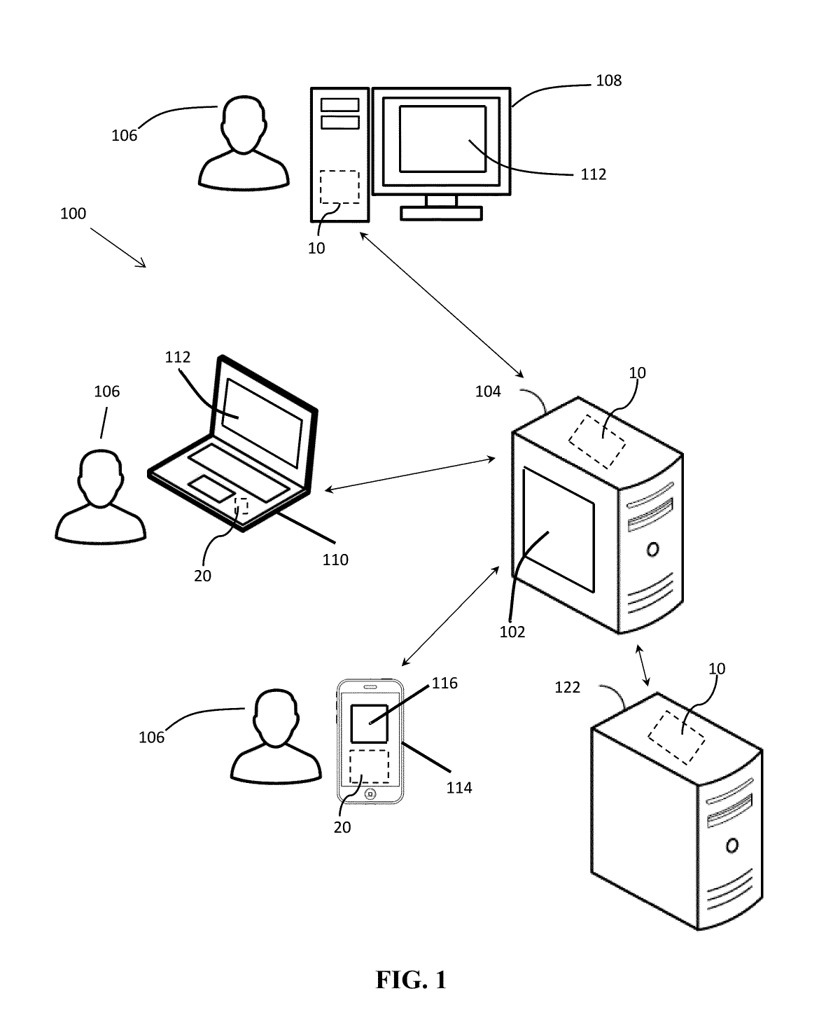

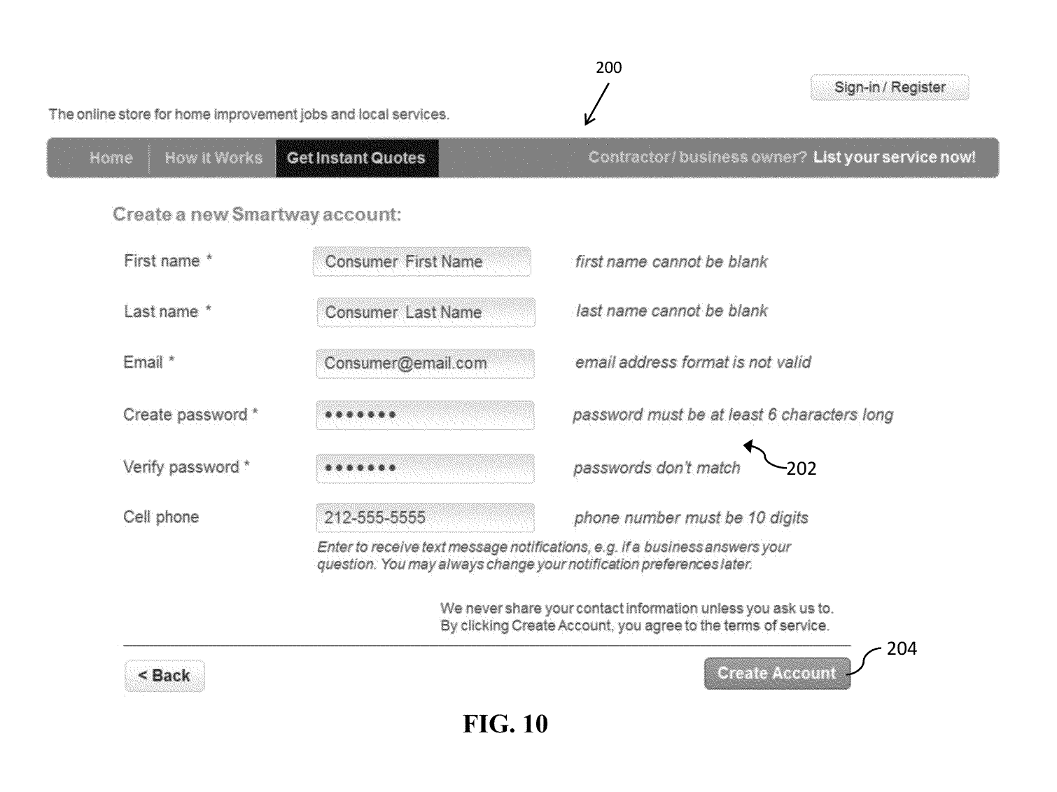

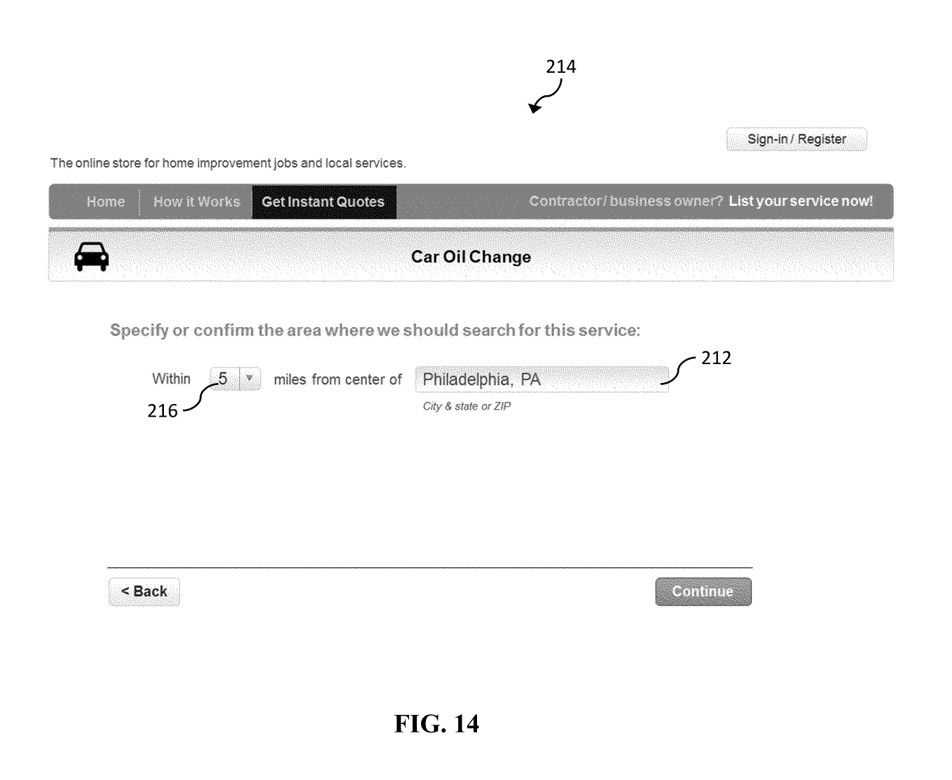

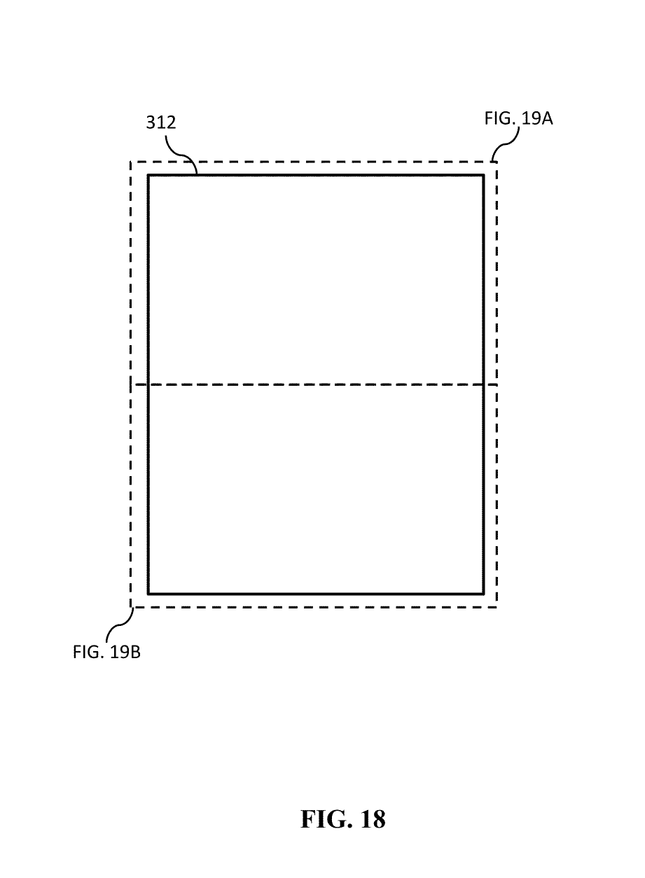

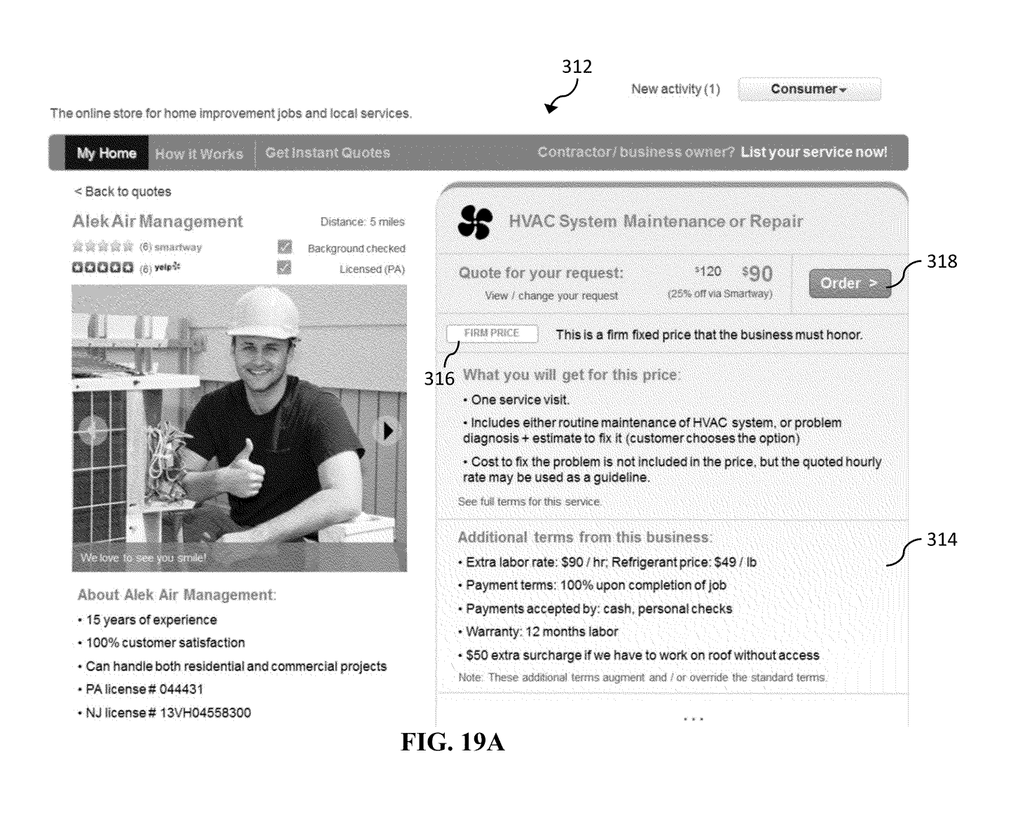

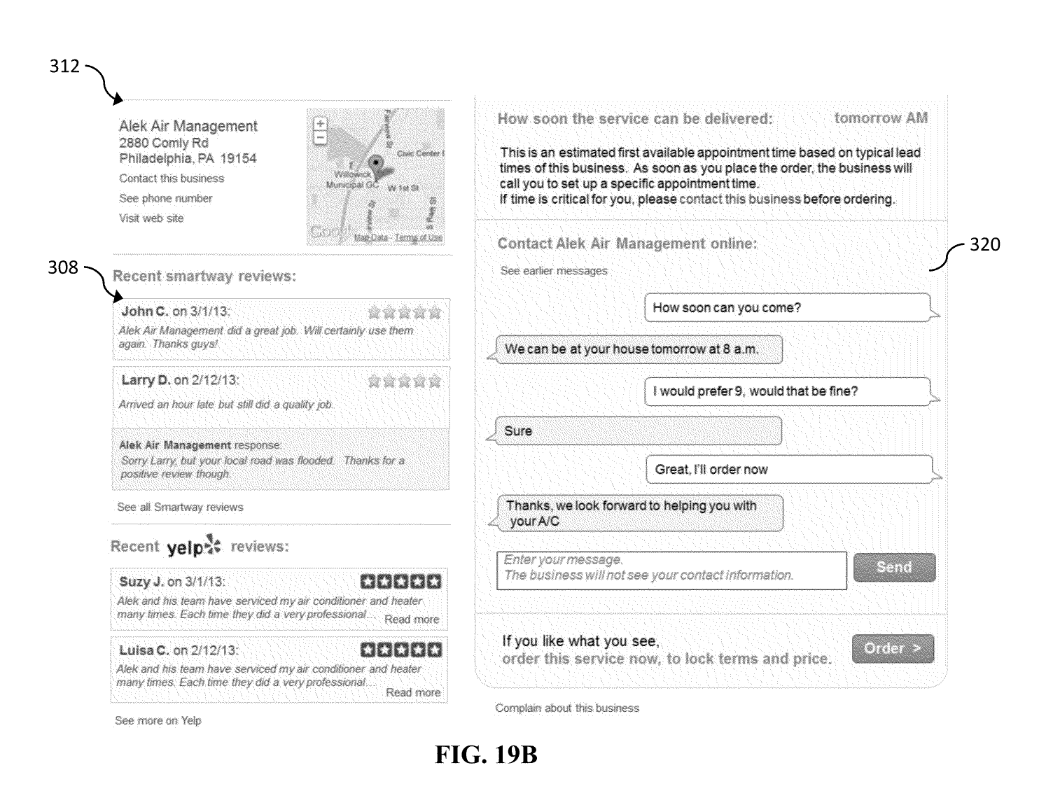

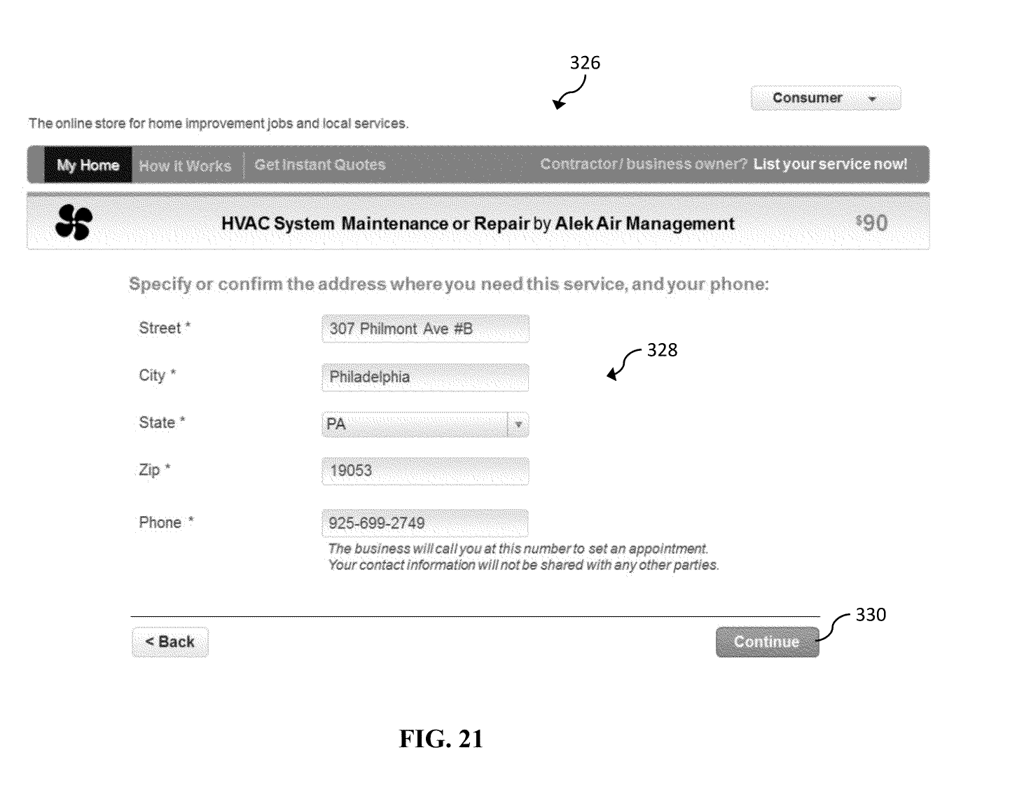

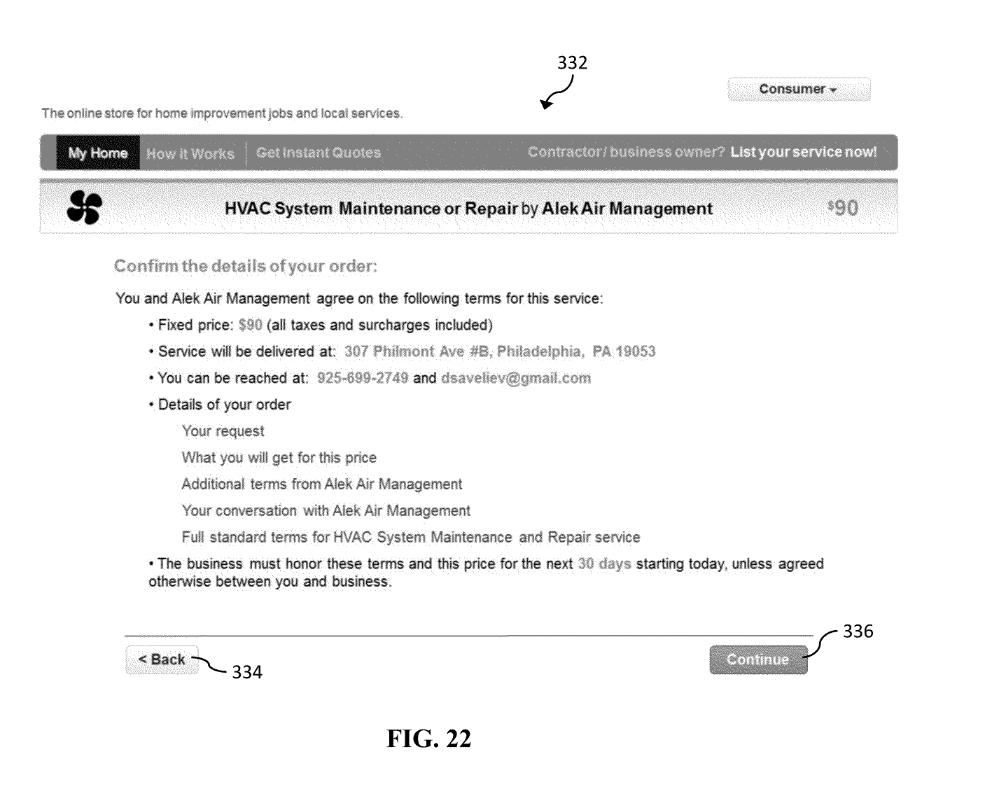

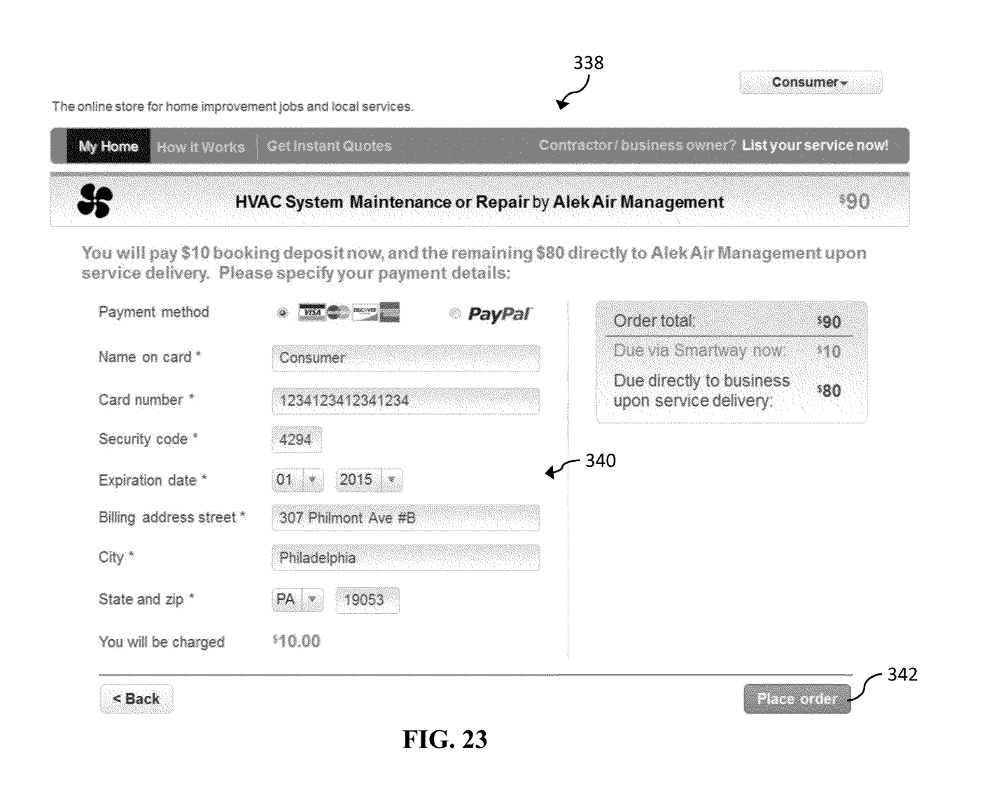

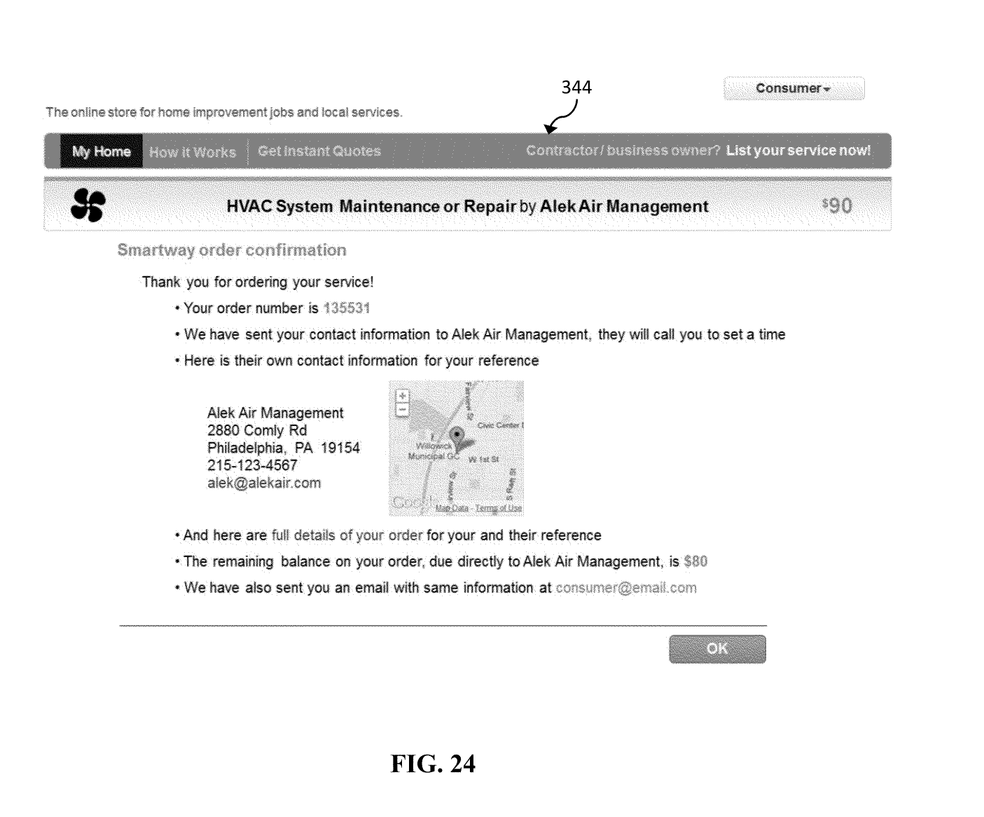

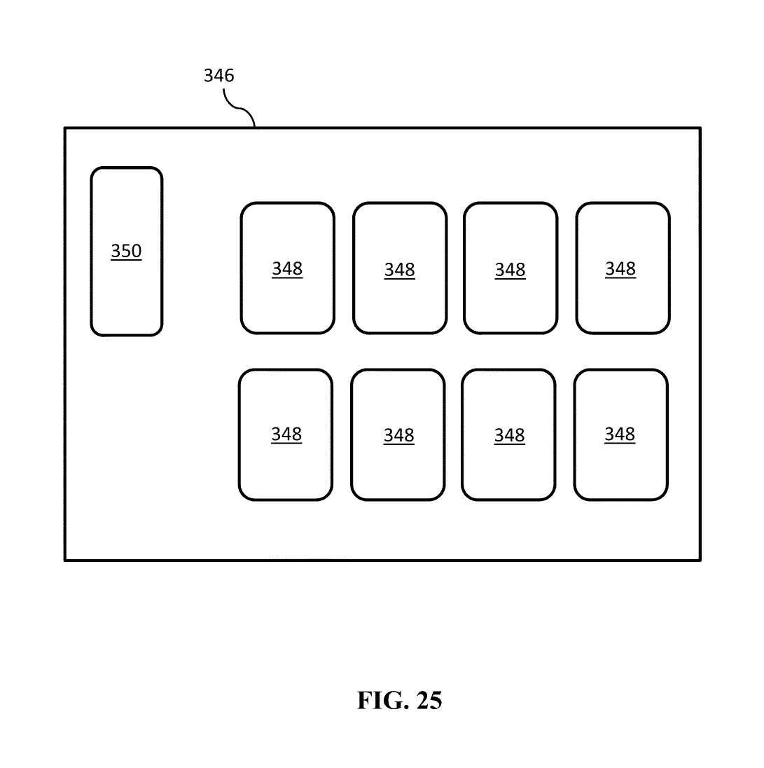

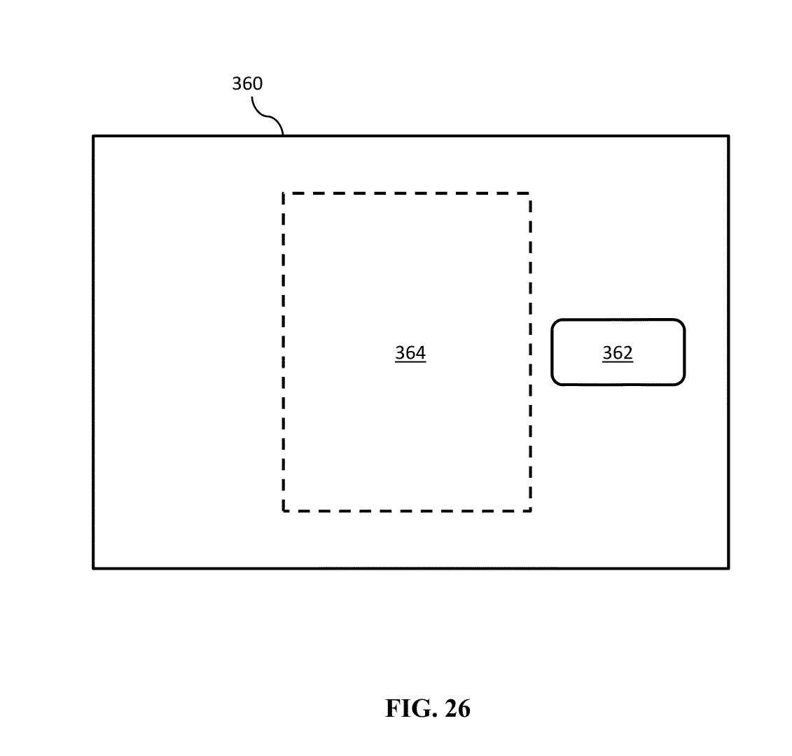

The systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, methods etc. are either related to a specific example presented or are merely a general description of such a technique, arrangement, method, etc. Identifications of specific details or examples are not intended to be and should not be construed as mandatory or limiting unless specifically designated as such. Selected examples of systems, arrangements, and methods for facilitating an online marketplace for services are hereinafter disclosed and described in detail with reference made to FIGS. 1-26.

This disclosure includes a number of definitions that are identified at the end of this detailed description. For this disclosure, the terms “computing device,” “computer readable media,” “logic,” and “software” will include the definitions hereinafter provided in this detailed description.

Systems and methods can be arranged to provide consumers in the market for professional services with reliable quotes from a variety of service providers in an efficient and timely manner. The system and methods can provide such quotes without the need for consumers to meet in person with service providers or even without the consumer directly interacting with the service providers. The system and methods can further provide for the consumer to select a specific quote and service provider and enter into a binding contractual agreement with that service provider to render the desired professional service.

In one embodiment, access to such reliable quotes is facilitated through an online marketplace. The online marketplace can include backend systems combined with an internet-accessible website, mobile application, or other interface used by consumers to access the online marketplace. The online marketplace can provide for a consumer to specify through the website, mobile application, or other interface the category of service required, including the specific details of the required service that define the parameters of complex services (i.e., the “service request”). The online marketplace can return automatically generated quotes from any number of service providers in real-time. This is to say that the online marketplace can return the quotes while the consumer is using the online marketplace via the website, mobile application, or other interface. The quotes for the service request can include, for example, pricing for completing the service, a full written description of the service, a date for the service provider to start the service, and a date that the service provider will finish performing the service.

Such real-time quoting can allow the consumer to compare the quotes for the service request and select the quote most appealing to the consumer during one session of using the online marketplace. The online marketplace can also provide for the consumer and the service provider to each agree to a binding contract so that the consumer can be assured that the service provider will complete the service request, and the service provider can be assured that the consumer will pay for the service request.

The online marketplace can provide for a number or service providers to register with the online marketplace. Such registration can be achieved via internet-enabled websites, mobile applications, or other interfaces designed for use by service providers. Each service provider can create a “service listing” specific to that service provider. A service listing can be defined by service listing parameters. The service listing parameters can establish rules and pricing parameters that define the manner in which that service provider is willing to fulfill service requests and at what price that service provider will fulfill service requests. Exemplary service listings can include rules that define what services the service provider is willing to provide; whether the service provider accepts residential projects, commercial projects, or both; what types and brands of equipment the service provider will service, install, or replace; and so on. Exemplary service listings can also include pricing parameters such as costs of parts and systems (such as a price list for a particular manufacturer of heat pumps of varying efficiencies and capacities); labor costs for various service requests; cost of accomplishing additional tasks that are needed to complete the service request; and so on.

In one specific example, a service provider can select the category of services it is willing to provide. A first service provider might have the personnel, equipment, and skill level to offer bathroom and kitchen remodeling services; therefore, in its service listing, the first service provider indicates that it offers bathroom and kitchen remodeling services. A second service provider might have the personnel, equipment, and skill level to offer roofing and siding replacement and repair services; therefore, in its service listing, the second service provider indicates that it offers roofing and siding replacement and repair services. In another example, service providers' service listings can define how the service provider prices labor costs for service requests. A service listing can include labor costs for certain tasks required by a consumer's service request. For example, an HVAC service provider's service listing can include a first cost for installing an HVAC condenser on the ground level of a commercial building and a second, higher cost for installing the same HVAC condenser on the roof of a similar commercial building. In another example, the HVAC service provider's service listing can have a first price for replacing an HVAC evaporator coil in a relatively small closet of a residence and a second, lower cost for replacing that same HVAC evaporator coil in an open space in the basement of a residence. A service listing can also include costs for commonly required tasks that accompany service requests, such as the cost for applying for and receiving the proper permits from the applicable municipality, the cost of a crane or position an HVAC condenser on the roof of a building, and so on.

The online marketplace can provide for a consumer to describe the complexity of a service request. For example, the consumer can select the general category of service required—HVAC replacement, home remodeling, auto service, etc. Once the consumer provides the general category of service required, the online marketplace can provide the consumer a series of questions directed to detailing the complexity of the particular service. The list of questions can be specific to the general category of services selected by the consumer. The list of questions can be written by industry experts that are knowledgeable in rendering the services. The questions can be written in a manner that is easily understandable to consumers that might not have sufficient background to understand technical terms and issues.

Based on the service listings provided by service providers and a service request provided by a consumer, the online marketplace can generate quotes for each service provider that offers the service requested by the consumer. The information provided by the service providers and the answers to the questions presented to the consumer are selected such that the online marketplace can provide the consumer with reliable quotes that can be the basis for a contractual agreement between the consumer and the service provider. As will thus be understood, the online marketplace can then provide an agreement with sufficient contract terms to bind both the consumer and the service provider. The consumer can electronically sign the agreement to be bound, while the service provider can provide the authority required to be bound to the agreement at the time of registering with the online marketplace and/or when providing the details of the service listing specific to the service provider.

It will be understood that such an online marketplace can provide the consumer with reliable quotes for complex service requests. The consumer can agree to the price and description of the service request on the quote, and purchase the service request with confidence that the consumer is receiving a good value.

FIGS. 1, 2, and 3 schematically illustrate one embodiment of an online marketplace 100. As illustrated in FIG. 1, the online marketplace 100 can include a service request fulfillment engine 102 that resides on one or more servers 104 and one or more consumer interfaces that provide consumers 106 with remote access to the service request fulfillment engine 102 from a computing device. The one or more servers 104 can comprise server hardware 10. The server hardware 10 can comprise one or more processors 12 communicatively coupled to server memory 14 (generally depicted as double arrowed lines). As used herein, the term “processor” can mean any device capable of executing machine readable instructions. Accordingly, each processor can be an integrated circuit, a microchip, or any other device capable of implementing logic. The server memory 14, client memory 24, or both described herein may be RAM, ROM, a flash memory, a hard drive, or any computer-readable medium capable of storing machine readable instructions. It is noted that the functions, modules, and processes described herein can be provided as machine readable instructions stored on the server memory 14 and executed by the one or more processors 12. Additionally, it is noted that the phrase “communicatively coupled,” as used herein, can mean that components are capable of exchanging data signals with one another such as, for example, electrical signals via conductive medium, electromagnetic signals via air, optical signals via optical waveguides, and the like.

The one or more processors 12 can also be communicatively coupled to a server communication module 16 for communicatively coupling the one or more servers 104 to another device via a network such as, for example, a wide area network, a local area network, personal area network, or any combination thereof. Accordingly, the server communication module 16 can be configured to communicate, i.e., send, receive, or both, data signals via any wired or wireless communication protocol. For example, the server communication module 16 can comprise an antenna, a modem, LAN port, wireless fidelity (Wi-Fi) card, WiMax card, near-field communication hardware, satellite communication hardware, or the like. Accordingly, the one or more servers 104 can be communicatively coupled to a network via wires, via a wide area network, via a local area network, via a personal area network, via a satellite network, or the like. Suitable local area networks can comprise wired Ethernet and/or wireless technologies such as, for example, Wi-Fi. Suitable personal area networks can comprise wireless technologies such as, for example, IrDA, BLUETOOTH, Wireless USB, Z-WAVE, ZIGBEE, or the like. Alternatively or additionally, suitable personal area networks may include wired computer buses such as, for example, USB and FIREWIRE. Thus, any components of the one or more servers 104 can utilize one or more network components to communicate signals via the Internet or World Wide Web. It is noted that the term “signal,” as used herein, can mean a waveform (e.g., electrical, optical, magnetic, or electromagnetic), such as DC, AC, sinusoidal-wave, triangular-wave, square-wave, and the like, capable of traveling through a medium.

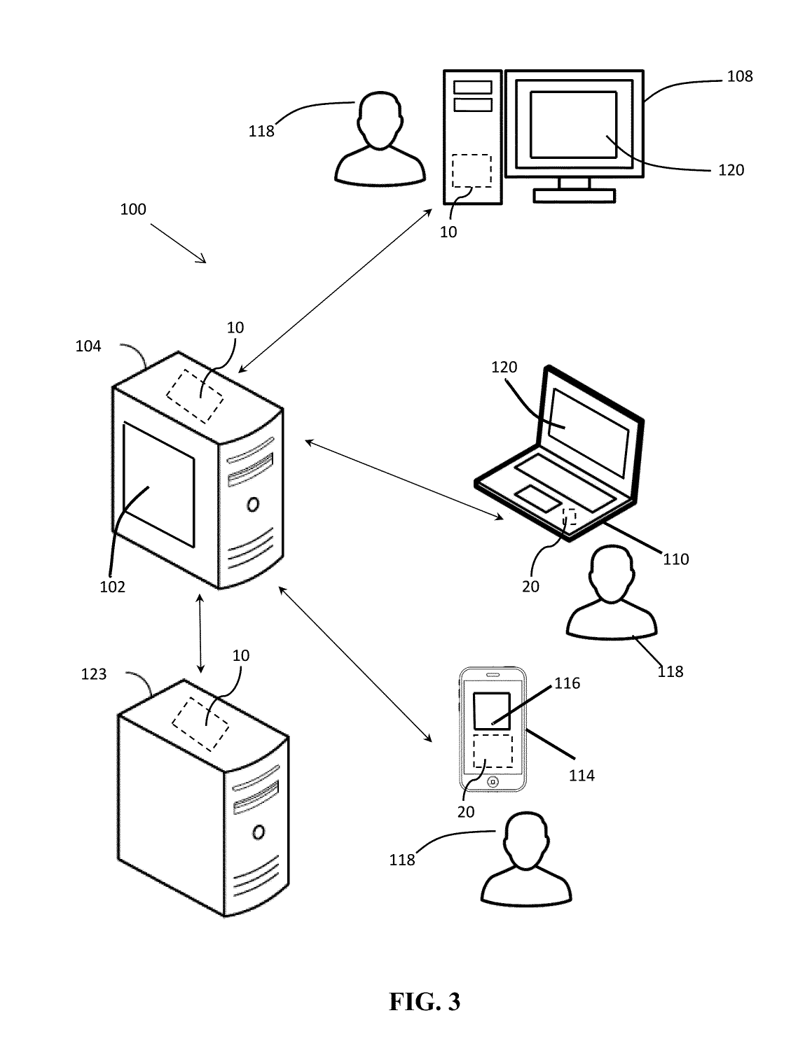

It is noted that, while the one or more servers 104 is schematically depicted in FIGS. 1 and 3 as being a single machine, each of the one or more processors 12, the server memory 14, and the server communication module 16 can be distributed amongst a plurality of machines that are communicatively coupled to one another. Accordingly, the one or more servers 104 can be scaled to include any number of machines suitable for meeting the demands of the server functions. In some embodiments, the one or more processors 12 can execute web server software provided as machine readable instructions such as, but not limited to, via storage on the server memory 14. Suitable web server software includes, but is not limited to, Apache HTTP Server, Internet Information Services, Nginx, Google Web Server, or the like. Accordingly, the one or more servers 104 can utilize a server operating system such as, for example, UNIX, Linux, BSD, Microsoft Windows, or the like.

According to the embodiments described herein, consumers 106 can access the service request fulfillment engine 102 using a personal computer 108 or laptop computer 110 through an internet-enabled website 120 provided using the one or more servers 104. In some embodiments, consumers 106 can access the service request fulfillment engine 102 using a mobile device 114 such as a smart phone or a tablet using a mobile application 116 in communication with the one or more servers 104. In some embodiments, each of the personal computer 108, the laptop computer 110, and the mobile device 114 can comprise client hardware 20. The client hardware 20 can comprise one or more processors 22 communicatively coupled to client memory 24. The one or more processors 22 can also be communicatively coupled to a client communication module 26, which can be configured like the server communication module 16 described above. In some embodiments, the client communication module 26 can comprise radio frequency hardware (RF hardware) for communicatively coupling a cellular network. Suitable cellular networks include, but are not limited to, technologies such as LTE, WiMAX, UMTS, CDMA, and GSM.

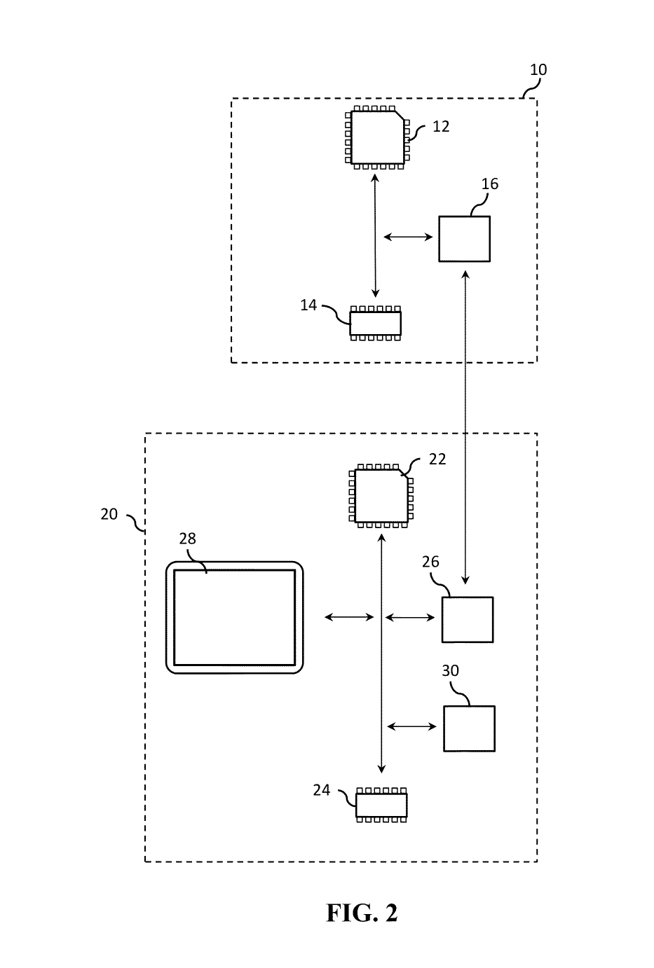

Referring to FIG. 2, the client hardware 20 can comprise a display 28 communicatively coupled to the one or more processors 22 for providing a user interface via the transmission of optical signals. In some embodiments, the display 28 can comprise a plurality of pixels that can decode a signal provided by the one or more processors 22 to selectively illuminate pixels to provide a user interface such as, but not limited to, an internet-enabled website 120 or a mobile application 116. The display 28 can comprise light emitting diodes (LED or OLED), liquid crystal display (LCD), liquid crystal on silicon (LCOS), or the like.

The client hardware 20 can comprise one or more input device 30 for sensing user input and encoding the input into a signal indicative of the user input. Suitable examples of the one or more input device 30 include a keyboard, a mouse, a touch screen, a camera, a microphone, or the like. Accordingly, the display 28 can be configured to operate as a touch screen for accepting input via visual controls or objects. Accordingly, the display 28 can comprise an input device 30 configured as a touch detector such as, for example, a resistive sensor, capacitive sensor, or the like.

As illustrated in FIG. 3, the online marketplace can further include one or more service provider interfaces that provide service providers 118 with remote access to the service request fulfillment engine 102 from a computing device. In one example, service providers 118 can access the service request fulfillment engine 102 using a personal computer 108 or laptop computer 110 through an internet-enabled website 120. In another example, service providers 118 can access the service request fulfillment engine 102 using a mobile device 114 such as a smart phone or a tablet using a mobile application 116.

It will be understood by those of ordinary skill in the art that although examples of computing devices described and shown herein are of personal computers, laptops, and smart phones, any device comprising a processor and a communication module that can send and retrieve information can be used by consumers 106 and service providers 118 to access the service request fulfillment engine 102. Although examples of interfaces described and shown herein are of internet-enabled websites and mobile applications, any number of interfaces can be used that facilitate interaction between consumers 106 and service providers 118 and the service request fulfillment engine 102. The service request fulfillment engine 102 is described and illustrated as residing on one or more servers 104. However, it will be understood by those of ordinary skill in the art that such servers can be physical server or a virtual server.

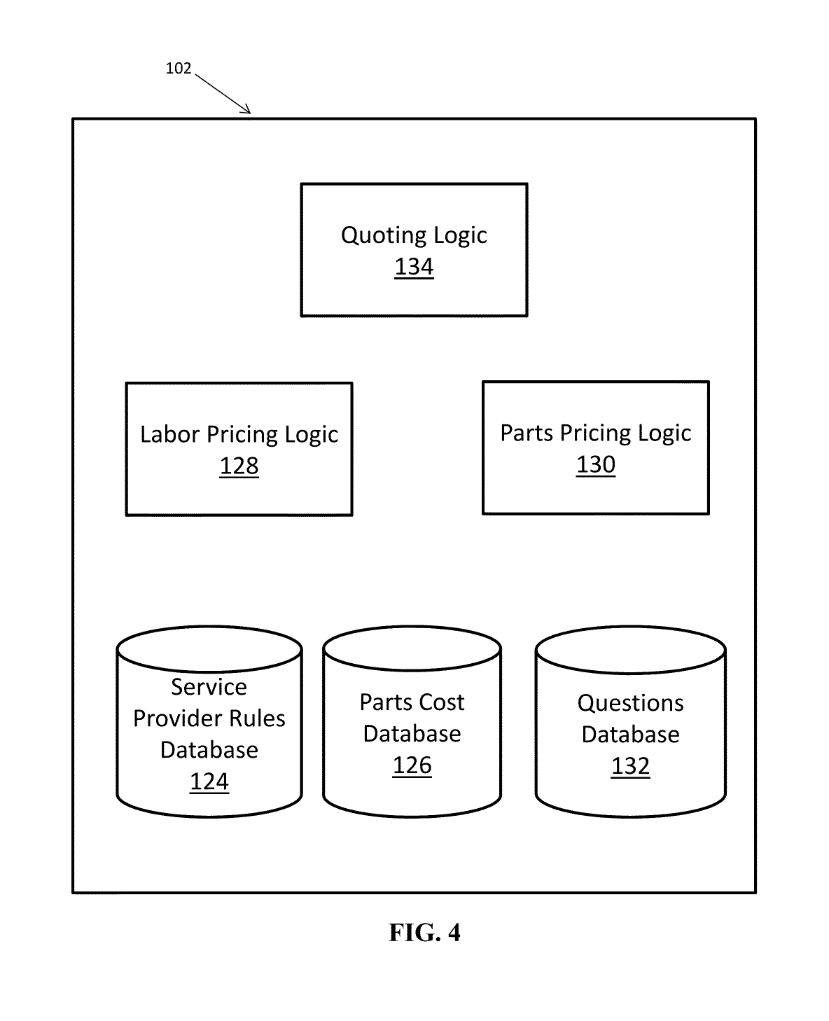

As will be subsequently described in detail the service request fulfillment engine 102 can include a number of components, modules, software, and databases that facilitate the online marketplace 100. For example, as schematically illustrated in FIG. 4, the service request fulfillment engine 102 can include one or more of the following: service provider rules database 124, a parts cost database 126, labor pricing logic 128, parts pricing logic 130, questions database 132, and quoting logic 134.

Generally, information and data regarding service listings of the service providers 118 is stored in the service provider rules database 124 and the parts cost database 126. The service provider rules database 124 generally includes specific rules inputted by each service provider regarding the manner in which the service provider will render services and the cost of labor and other tasks related to rendering those services. As noted above, service providers can select which services it will offer through the online marketplace 100, the cost of certain tasks required to complete services, etc. Such service provider specific information is stored as rules in the service provider rules database 124 for retrieval during the quoting process. The parts cost database 126 is a database of the cost of parts and systems required to complete specific services. For example, if the online marketplace 100 is quoting services for the replacement of an HVAC system, the cost of a specific HVAC system hardware can be drawn from the parts cost database 126 to include in a quote presented to a consumer.

The labor pricing logic 128 is logic that calculates the specific and customized labor costs for each service provider based on the rules the service provider adds to the service provider rules database 124. The service provider can include price parameters that adjust the labor costs, such as providing a discount based on volume of labor required to complete the service request. Once the labor pricing logic 128 calculates the labor costs for a service provider, the labor cost can be included in the quote presented to the consumer.

The parts pricing logic 130 uses costs retrieved from the parts cost database 126 to calculate the cost of systems, hardware, and other parts required to complete the service request. In one embodiment, as part of the service listing, the service provider provides a customized price sheet listing the costs for the systems, hardware, etc. that the service provider needs to perform services. The service provider can customize its price list to include pricing that is custom to the service provider due to the service provider's relationship with certain vendors for example. In another embodiment, in addition to a customized price list, the service provider can provide one or more pricing rules that can be used by the parts pricing logic 128 to apply any adjustments or discounts required. For example, certain service providers may have negotiated discounts with certain manufactures that can be included in the quote. In another example, cost of parts can rely on variables such as the “ship to destination” or discounts for form of payment, etc., that can increase or decrease the cost of the part as listed in the parts cost database 126.

The questions database 132 can include lists of questions presented to the consumer for each category of service the consumer selects and questions presented to each service provider when the service provider registers with the online market 100 and provides its service listing. In one embodiment, the questions can be generated by the execution of software code, stored in tables, etc. Finally, the quoting logic 134 is logic that assembles the quote, including pricing, description of services, contract terms, and any other information required, and delivers the quote to the consumer. The quoting logic 134 can also apply global pricing rules that apply to both labor costs and parts costs. In one example, a service provider can offer a standard discount from its ordinary pricing for all orders processed through the service request fulfillment engine 102. The quoting logic can apply this discount once the labor costs and parts costs are calculated and totaled.

As described in the following examples and illustrated in the figures, the service request fulfillment engine 102 can provide service providers and consumers with the ability to provide information to the online marketplace 100 and receive information from the online marketplace 100. Such flow of information can be facilitated by various forms of functionality including user interfaces.

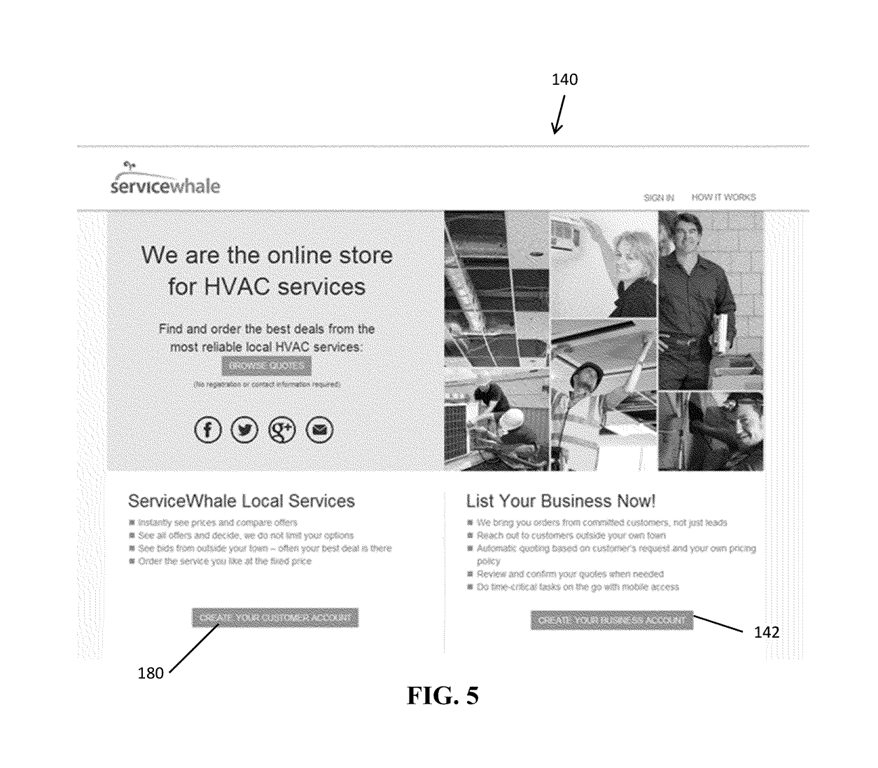

In order to generate quotes for consumers, the online marketplace 100 needs a number of available service providers to perform services requested by consumers. Therefore, the service request fulfillment engine 102 provides the functionality for one or more service providers to register with the online marketplace 100 and enter information that is customized to the specific service provider. FIGS. 5-9 illustrate examples of webpages that provide for service providers to submit information to the online marketplace.

FIG. 5 illustrates a webpage 140 of an internet-enabled website. The webpage 140 includes a button or link 142 that provides for a service provider to register with the online marketplace. The service provider can subsequently provide detailed information about its business. For example, the service provider can provide the name and location of the business, marketing materials that describe the business, links to the service provider's own website, evaluations of the service provider, etc. The service request fulfillment engine 102 can present the service provider with a list of services promoted through the online marketplace 100. The service provider can select the categories of services it is willing to provide. For instance, the service provider can select HVAC services.

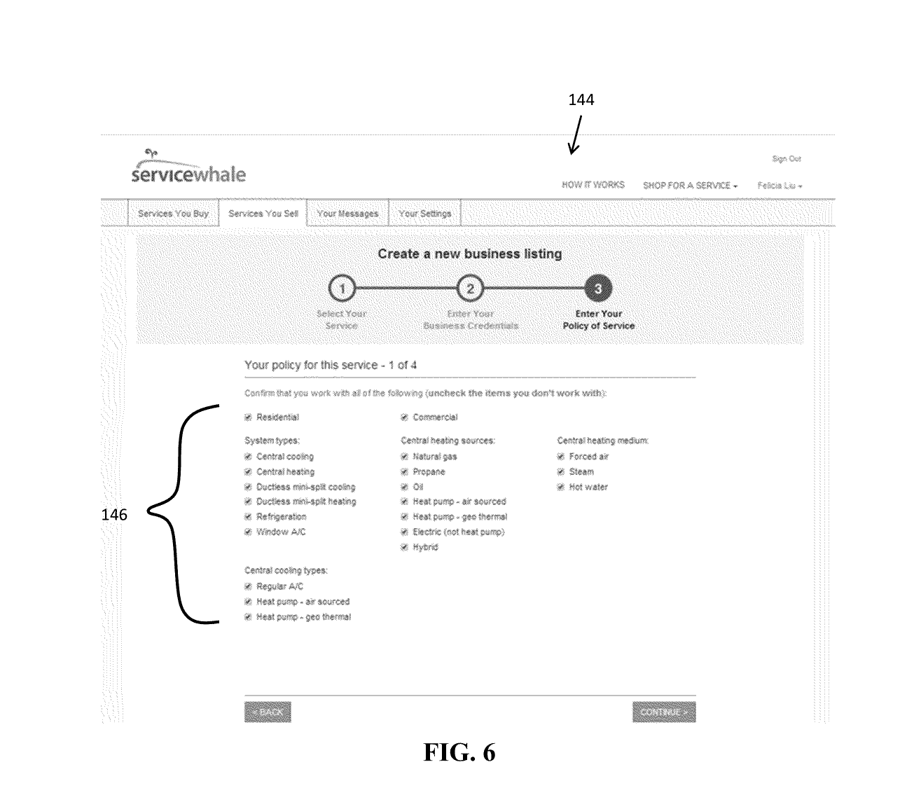

Upon such a selection, the service request fulfillment engine 102 can be configured to receive service listing parameters. Specifically, FIGS. 6-9 provide a method for receiving service listing parameters for installing or replacing an HVAC system, which are described below in greater detail in Tables 1A through 1E. Values for the service listing parameters can be collected using questions associated with the type of service in the questions database 132. The values can be associated with the service provider 118 in the service provider rules database 124. In some embodiments, the service provider 118 can be presented with a webpage 144, as illustrated in FIG. 6, with a number of potential selections 146 to specifically identify the types of HVAC services the service provider is capable and willing to offer. For example, the service provider can select from choices such as residential HVAC services, commercial HVAC services, or both. The service provider can also specify the specific type of HVAC systems it can install and/or service such as central heating, central cooling, natural gas, heat pump, and so on. The potential selections 146 presented in FIG. 6 are one example of the type of questions that the service request fulfillment engine 102 can provide to a service provider 118. It will be appreciated that FIG. 6 is an example only. Such webpages can be developed for any number of types of services from any number of categories of services. Specifically, non-limiting examples of service listing parameters are described below for a plurality of exemplary service types. It will also be appreciated that such selections as illustrated in FIG. 6 can be used to generate rules that can be stored in the service provider rules database 124.

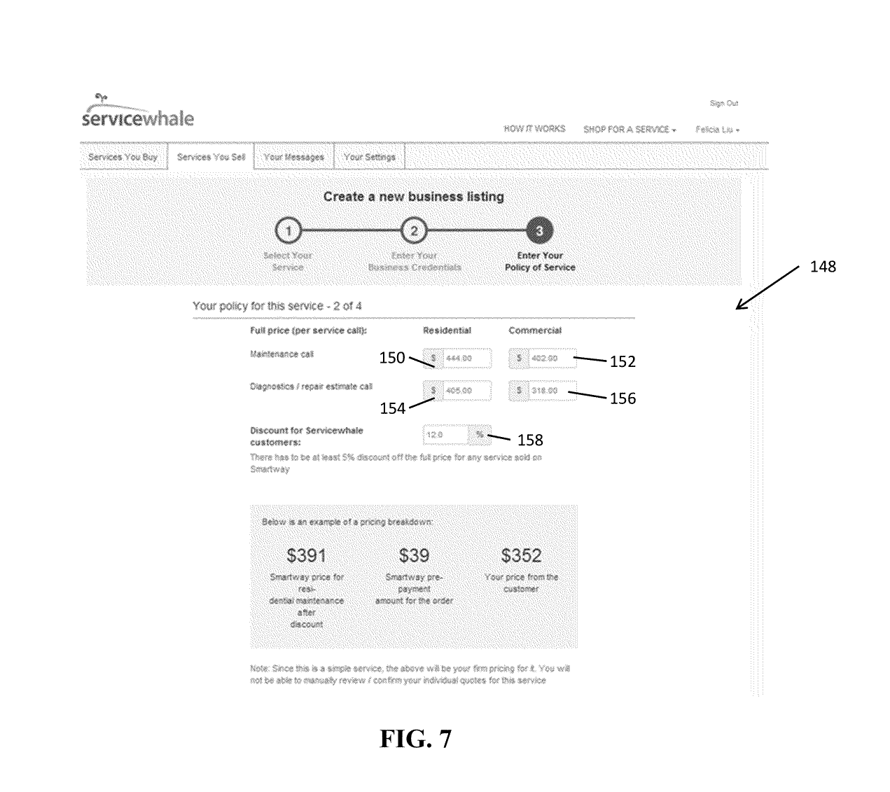

The service request fulfillment engine 102 can provide webpages for the service provider to provide information on how it prices its services. FIG. 7, illustrates such a webpage 148 presented to a service provider that has selected the option of providing HVAC services. The webpage 148 can provide entry fields for the service provider to enter pricing policies for basic residential maintenance calls 150 and basic commercial maintenance calls 152. The service provider can also enter pricing policies for diagnostic residential calls 154 and diagnostic commercial calls 156. The service provider can enter a discount amount into a field 158 indicating the discount offered to consumers purchasing services through the service request fulfillment engine 102. It will be appreciated that the amounts entered into fields 150, 152, 154, and 156 and the discount entered into field 158 can be used to generate rules that can be stored in the service provider rules database 124. Furthermore, such rules can be used by the labor pricing logic 128 to generate an accurate amount for any requested quote. For example, the labor pricing logic 128 can retrieve the cost of a basic residential maintenance call (which is originally entered in field 150 and results in the generation of a rule) and apply the appropriate discount (which is originally entered in field 158 and results in the generation of a rule). The resulting amount can be displayed on a quote.

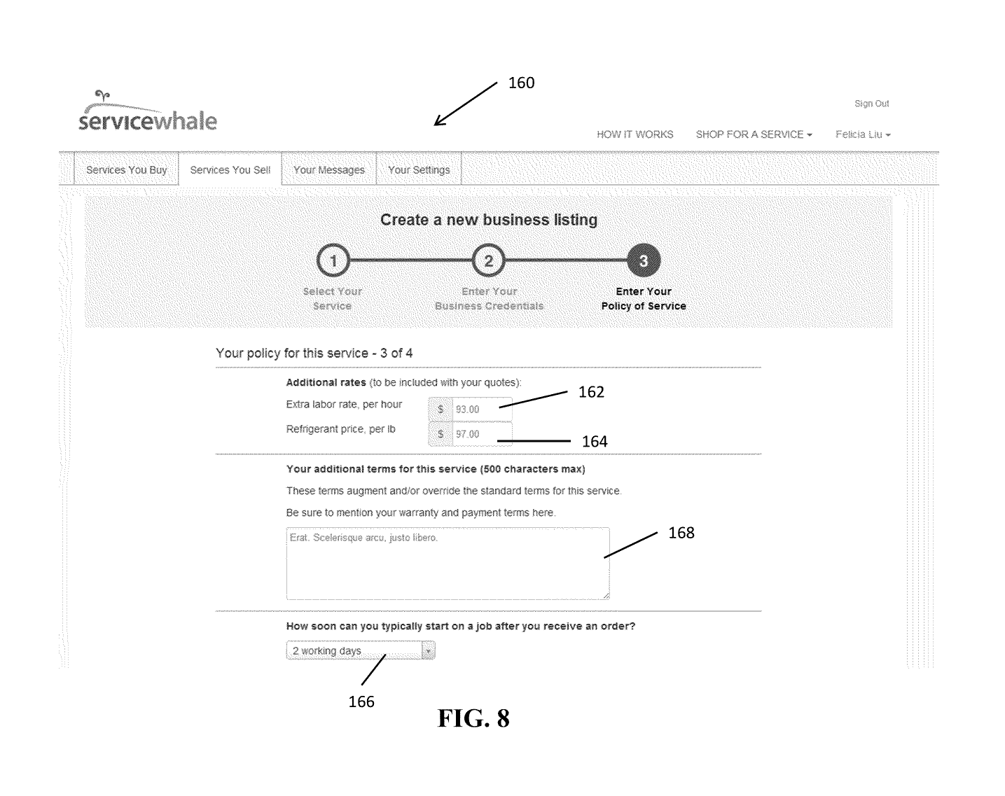

One or more additional webpages can be presented to the service provider to gather all necessary information required for accurately preparing quotes. In one example, again for HVAC services, the service provider can be presented with a webpage 160 as illustrated in FIG. 8. The webpage 160 can include entry fields for the service provider to enter additional pricing information common to HVAC services such as hourly labor costs 162 and cost of refrigerant 164. The webpage 160 can also include fields where the service provider can enter a typical lead time required before beginning a job 166 and a field 168 to enter additional conditions specific to the service provider such as terms of warranty and payment terms.

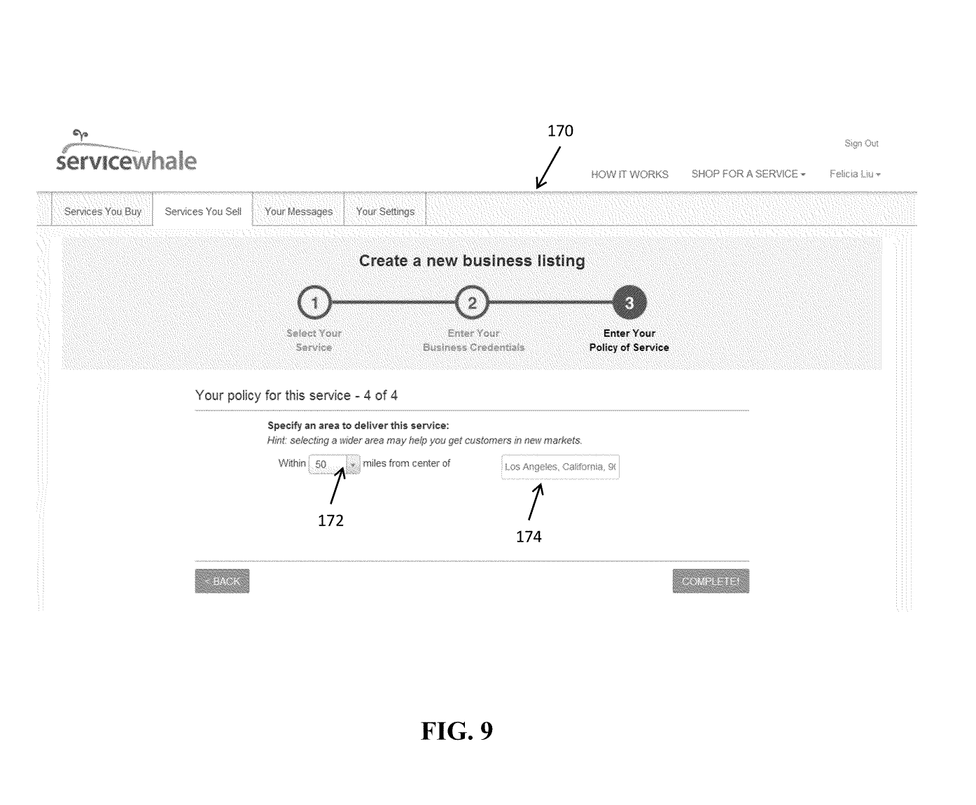

FIG. 9, illustrates yet another example of a webpage 170 that can be presented to a service provider. The webpage 170 can include a pair of fields 172, 174 that can define the geographic area serviced by the service provider. For instance, the service provider 118 can enter a geographic location such as a specific city or zip code in field 174, and can enter a radius in field 172, i.e., the radius in miles from the service provider's location that the service provider is willing to travel to perform service. Alternatively or additionally, the service provider 118 can enter a geographic location to be excluded from quoting. It will be appreciated that FIGS. 6-9 provide only examples of the type of information that can be collected from and/or input by the service provider to generate rules that will result in accurate and reliable quotes that consumers can rely upon when purchasing services.

As noted above, the service request fulfillment engine 102 can include a parts cost database 126. System administrators can populate the parts cost database 126 by contacting parts and system manufacturers to obtain retail pricing information. In another example, service providers can also provide retail pricing to the parts cost database 126. As will be appreciated, service providers that work with manufacturers on an ongoing basis may readily have access to retail pricing information.

As with the webpages described above that are designed for use by service providers 118 (FIGS. 6-9), the online marketplace 100 can include a number of webpages designed for and directed to consumers 106 using the online marketplace 100. Referring collectively to FIGS. 1, 5, and 10, the webpage 140 can include a button or link 180 that provides for a consumer 106 to register or create an account with the online marketplace 100. In one example, once a consumer 106 opts to register or create an account, the consumer 106 can be taken to a webpage 200. The webpage 200 can be configured for account creation. The webpage 200 can include fields 202 for receiving input corresponding to personal information such as first and last name, email address, telephone number and creation of a password. The webpage 200 can comprise a control 204 for receiving input to finalize the creation of the account. The online marketplace 100 can additionally provide functionality such as email verification, i.e., sending an email to the email address provided that requires some action to finalize the creation of the account, and password recovery methods. In addition, the online marketplace 100 can be arranged to allow for the submission of service requests without first providing any personal information. In such an embodiment, personal information about the consumer is collected at the time a service is ordered.

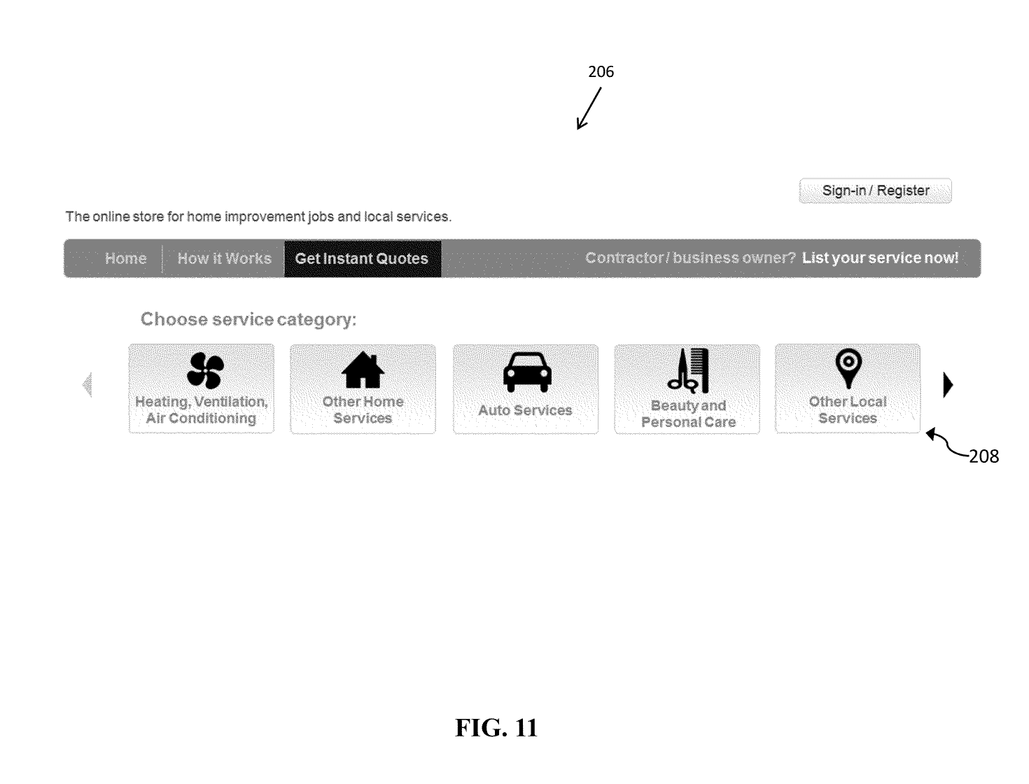

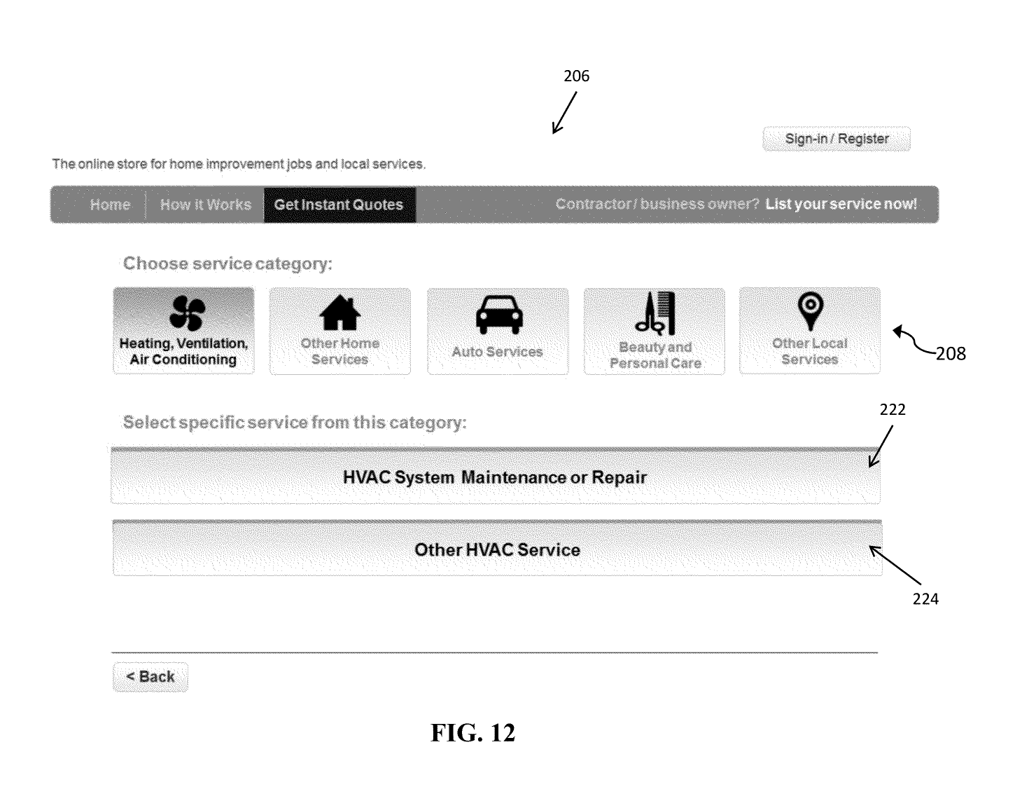

Referring collectively to FIGS. 1, 3, 4, 11, and 12, the consumer 106 can browse various services and receive quotes for those services such as, for example, after the consumer 106 has created an account. In some embodiments, the service request fulfillment engine 102 can provide a webpage 206 comprising a plurality of service category controls 208. Each of the service category controls 206 can correspond to service category that is one or more service provider 118 in the service provider rules database 124 such as, for example, “Heating, Ventilation, Air Conditioning;” “Other Home Services;” “Auto Services;” “Beauty and Personal Care;” and “Other Local Services.” The service category controls 208 can receive consumer 106 input indicative of the selection of a service category. In some embodiments, responsive to input received by a service category control 208, the webpage 206 can be updated (FIG. 11 to FIG. 12) to provide controls corresponding to the types of services associated with the selected service category in the service provider rules database 124. For example, if the service category control 208 corresponding to “Heating, Ventilation, Air Conditioning” is selected, controls can be provided corresponding to the available types of “Heating, Ventilation, Air Conditioning” services. Thus, the webpage 206 can be updated to provide a first type control 222 corresponding to “HVAC System Maintenance or Repair” and a second type control 224 corresponding to “Other HVAC Services.” Each of the first type control 222 and the second type control 224 can be configured to receive input indicative of the selection of a service type. Once a service type is selected, one or more additional webpages can be generated by the service request fulfillment engine 102 to gather values for the service request parameters associated with the selected type of service. The service request parameters are configured to parameterize information related to the consumer's 106 into parameters useful for generating an accurate quote for the service.

As illustrated in FIG. 12, the first type control 222 and the second type control 224 can be provided as buttons to receive input indicative of the type of service by the consumer 106. In addition to these examples, it will be appreciated that any number of graphic user interface controls, objects or fields, such as for example, buttons, radio buttons, split buttons, list boxes, sliders, spinners, etc., can be used to efficiently receive input that the system can use to define values of service listing parameters, service request parameters, or both.

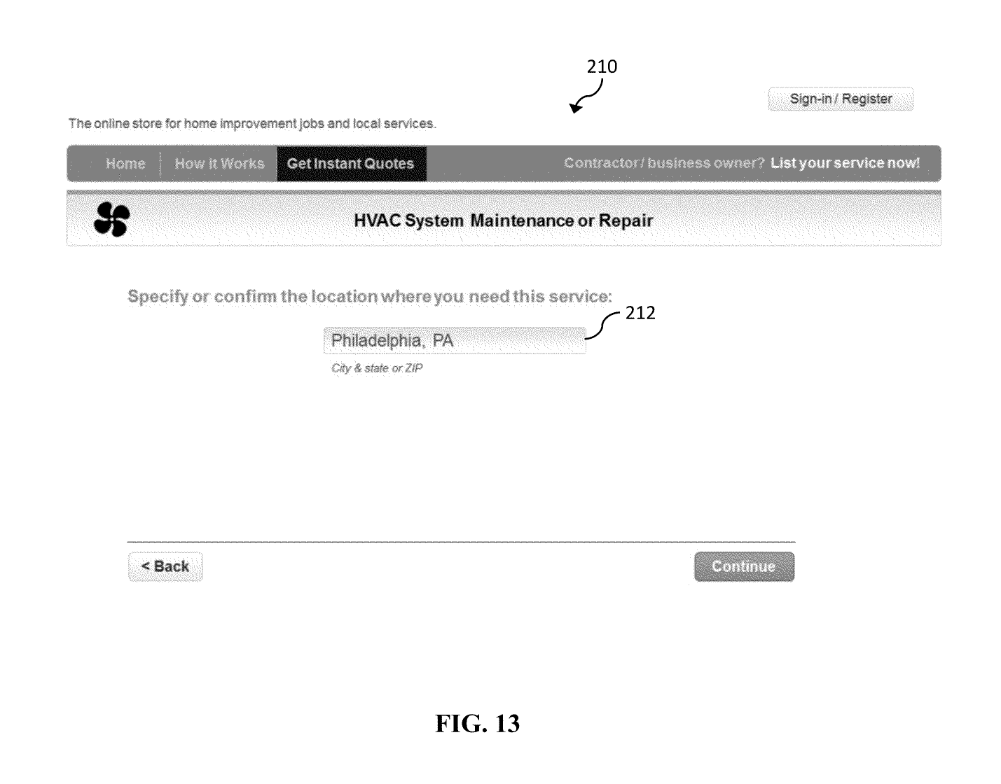

Referring collectively to FIGS. 4, and 13-16, a method for receiving input corresponding to service request parameters is depicted. Values for the service request parameters can be collected using controls and fields provided upon one or more webpages. Specifically, the webpages can present questions from the questions database 132 that correspond to the service request parameters for the selected service. It is noted that exemplary service request parameters are provided below. Thus, while particular service request parameters are described with respect to FIGS. 13-16, it is understood that values for any of the service request parameters described herein can be received as input responsive to questions of the questions database 132. In some embodiments, values for service request parameters related to geographic location where the services will be performed can be received using a webpage 210. For example, the webpage 210 can comprise a field 212 for receiving input indicative of a local such as, but not limited to, a city or zip code. In some embodiments, as the consumer 106 begins to enter the name of a city for example, matching cities are populated in a dropdown box to facilitate the entry of the desired city. In further embodiments, the service can be performed at a location that requires the consumer 106 to travel to obtain the service (such as auto repair for instance). Accordingly, values for service request parameters related to geographic location where the services will be performed can be received using a webpage 214 comprising a field 216 for receiving input indicative of a distance (e.g., radius) that the consumer 106 is willing to travel.

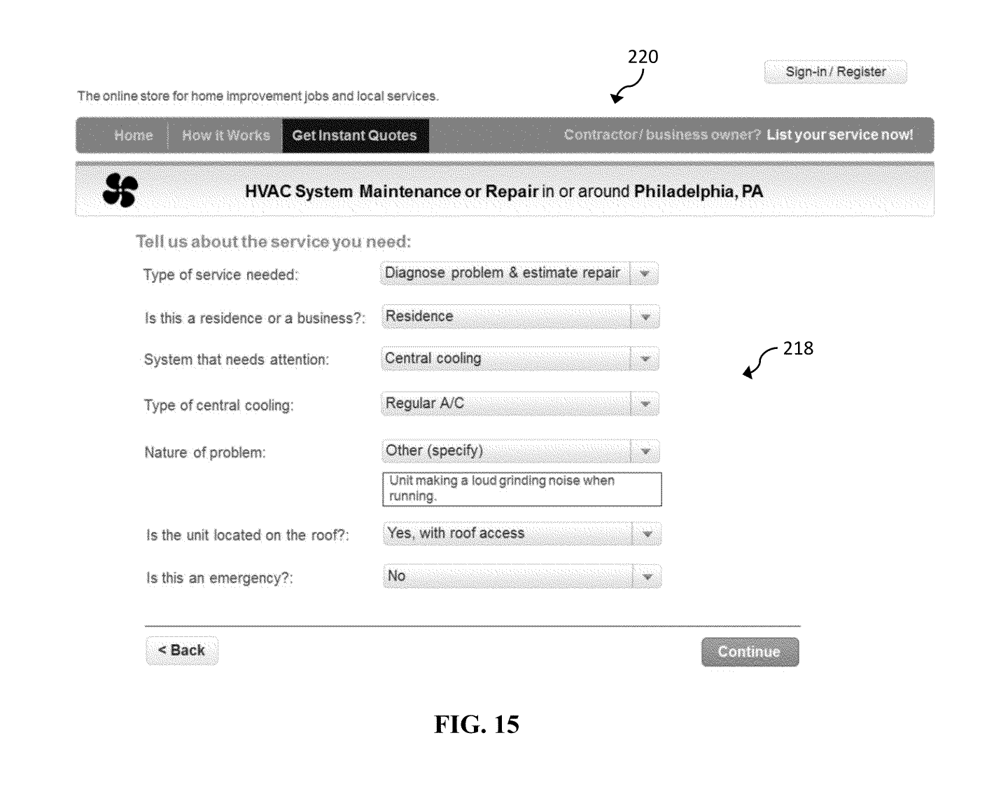

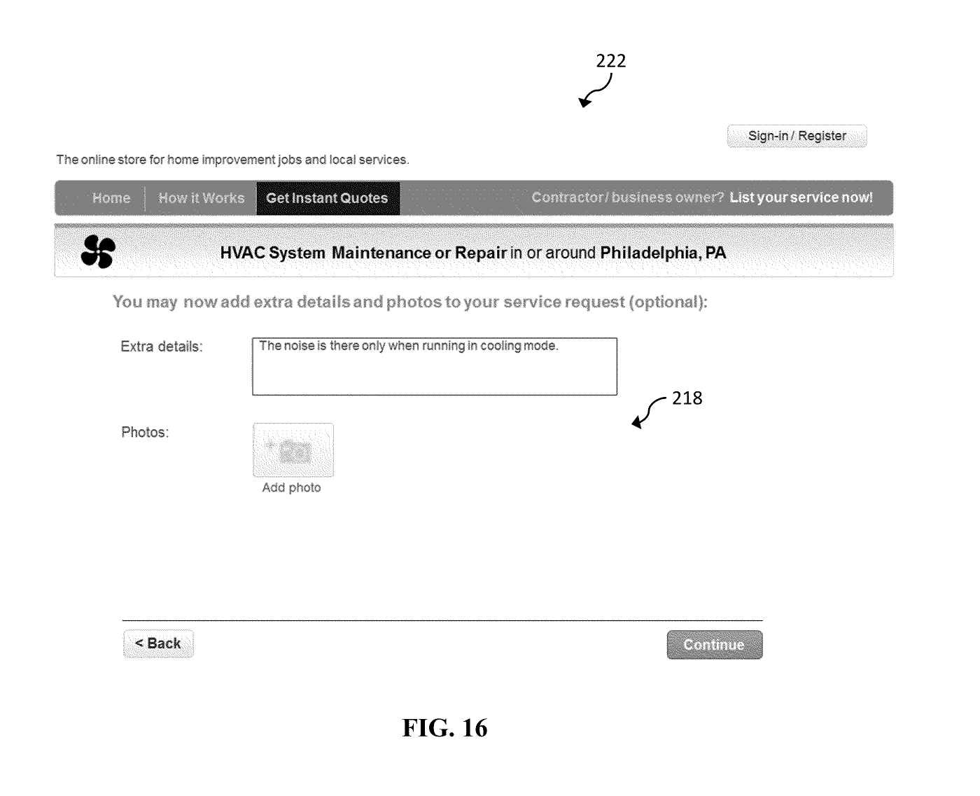

In addition to service request parameters related to a geographic location, questions can be provided with objects (e.g., fields, controls, or both) configured to receive input indicative of service listing parameters to describe more specifically the nature of the services required. For example, FIGS. 15 and 16 depict questions corresponding to the service request parameters for maintenance and repair of an HVAC system, which are described in greater detail below in Table 4. The consumer 206 can provide input indicative of values for the service request parameters such as, for example, the service will be performed at a residence, the service is for an air conditioning unit, which is located on the roof of the residence, and that there is no present emergency. Input indicative of values for the service request parameters can be received with fields 218 provided on webpage 220 and webpage 222. It is noted that the fields 218 can be configured to correspond to the inputs desired for the service request parameters. For example, service request parameters having predefined responses can be received with buttons, radio buttons, split buttons, list boxes, or the like. Service request parameters requesting freeform (e.g., narrative or numeric values) responses can be received with text boxes or the like. Moreover, service request parameters requesting files or images can be received as uploaded files.

The responses to questions received from the consumer 106 can be used by the service request fulfillment engine 102 to populate service listing parameters with values. The values can be used to automatically generate quotes for service requests submitted to the service request fulfillment engine 102 by the consumer 106. The service request fulfillment engine 102 can filter the service providers based on any number of variables. For example, the marketplace 100 can filter based on geographic location specified by the consumer (i.e., the Philadelphia area) and the specific service requested (i.e., HVAC system maintenance and repair for a residential home with the unit on the roof). In other examples, the service request fulfillment engine 102 can filter on type of equipment the service provider can provide, install or service. If a service request for a HVAC system includes a requested minimum seasonal energy efficiency rating (SEER rating), the service request fulfillment engine 102 can return quotes from only service providers that offer the requested SEER rated systems. For instance, if the service request specifies a SEER rating of 20, any service provider that does not have HVAC systems in its price list with SEER ratings of 20 or higher will be filtered out of the quoting process.

Other examples of filtering service providers include governmental rules and regulations. For example, some service providers are willing to file for and obtain local permits required to perform certain professional services. Other service providers expect the consumer to file for and obtain the required permits. If a consumer specifies that the service provider is to obtain required permits, any service providers that do not offer such service will be filtered out of the quoting process. In another example, a service provider's service area may extend into other jurisdictions, such as a service provider based in western New Jersey and licensed only in New Jersey can have a service area that extends into Pennsylvania. If a particular service request of a Pennsylvania resident includes services that require licensing in Pennsylvania, that service provider from New Jersey can be filtered out of the quoting process.

It will be appreciated that the service request fulfillment engine 102 processes information supplied by both consumers and the service providers regarding a number of requirements of a consumer's service request and capabilities of the service providers during the quoting process. Quotes will be generated only for those service providers that meet the consumer's criteria. Once the applicable service providers are determined, information provided by each service provider is used to generate quotes.

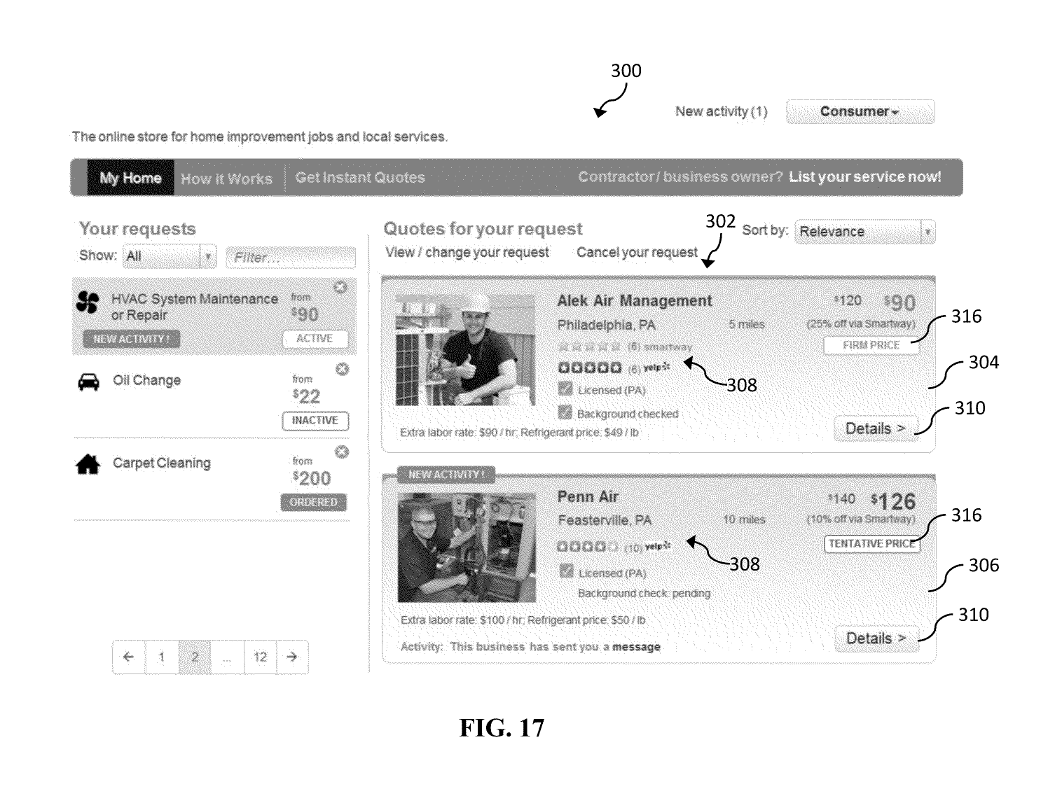

FIG. 17 schematically depicts a webpage 300 according to the embodiments described herein. The webpage 30 can be configured to provide a plurality of quotes 302 generated by the service request fulfillment engine 102 (FIG. 1). The quotes 302 can comprise a first quote object 304 and a second quote object 306 each configured to provide a quote summary. It is noted that, while FIG. 17 depicts the first quote object 304 and the second quote object 306, the webpage 300 can provide any number of quotes and quote objects. Each quote summary can provide visual indicia including, among other detail, the service provider's name and location, cost of service request, cost for additional labor, licensing information, and background check information.

Referring collectively to FIGS. 1, 3, and 17, each of the first quote object 304 and the second quote object 306 can comprise a third party review object 308 configured to provide visual indicia indicative of ratings associated with the service provider 118. Accordingly, each of the first quote object 304 and the second quote object 306 can be a composite object provided upon the webpage 300 that combines service rating information associated with the service provider 118 and provided by a third party. For example, a third party review server 122 can be communicatively coupled to the one or more servers 104. Thus, the one or more servers 104 can query and/or receive third party data from the third party review server 122. The third party review object 308 can be configured as visually perceptible elements of the third party, i.e., the visually perceptible elements can correspond to the look and feel of a review webpage provided by the third party (e.g., a website hosted by the third party review server 122). Since the composite objects are visually perceived by the consumer 106 as associated with the quotes 302, the consumer 106 is able to select a quote 302 (i.e., purchase a service) without being redirected to the website of the third party, thus allowing the online marketplace 100 to retain control over the consumer 106. Accordingly, the consumers 106 can quickly ascertain the relative quality of the quotes 302. Moreover, the consumer 106 can rely upon the reputation of the third party in comparing the service providers 108. As a result, service providers 108 with existing good online reputations can be incentivized to join the online marketplace 100 by being able to retain their earned reputation, and service providers 108 with existing bad online reputations can be prevented from avoiding their established reputation.

Referring collectively to FIGS. 1, 3, 17, 18, 19A, and 19B, the quote summary can assist the consumer 106 in quickly reviewing the quotes 302 and deciding which ones merit a more detailed review. In some embodiments, the each of the first quote object 304 and the second quote object 306 can comprise a detail view control 310 configured to redirect the consumer to a detailed view of the selected one of the quotes 302. For example, the consumer 106 can view greater detail for the quote associated with first quote object 304. Specifically, the consumer 106 can select the detail view control 310 and be directed to a webpage 312 that provides a more detailed quote summary. The webpage 312 can be arranged so that the consumer 106 is presented with detailed information about the service provider 118, such as the service provider's full profile, including the promotional material supplied by the service provider, photographs, reviews and ratings from other online marketplace consumers. Alternatively or additionally, the webpage 312 can comprise a third party review object 308 configured to provide reviews and ratings from respected third party rating services (i.e., the online reputation of the service provider 118).

According to the embodiments provided herein, the consumer 106 can interact with the service provider 118 associated with the first quote object 304. For example, the webpage 312 can comprise a communication application 316 that is configured to send, receive, and display written messages. Accordingly, the consumer 106 can exchange written messages with the service provider 118 via the communication application 316. Moreover, the written messages can automatically be associated with the quote.

In some embodiments, the webpage 312 can comprise a detailed quote 314 that provides visual indicia configured to comprehensively describe the terms and conditions of the quoted service. The webpage 312 can comprise a quote state object 318 configured to provide visual indicia corresponding to the state, as described in greater detail herein, of the associated quote. Alternatively or additionally, the webpage 312 can comprise a state change control 320 configured to receive input from the consumer. Upon receiving input with the state control object 320, the service request fulfillment engine 102 can automatically generate an event that changes the state of the quotes 302. For example, the state control object 320 can be provided as an “order” button that generates an order event that begins the process of ordering the service from the desired service provider 118 associated with the first quote object 304. In some embodiments, the event can automatically change the state of non-selected quotes. For example, the service request fulfillment engine 102 can be configured to automatically complete the order based upon purchase information associated with the consumer and stored in server memory 14. Alternatively or additionally, the service request fulfillment engine 102 can begin a process for collecting purchase information in response to input received by the state change control 320.

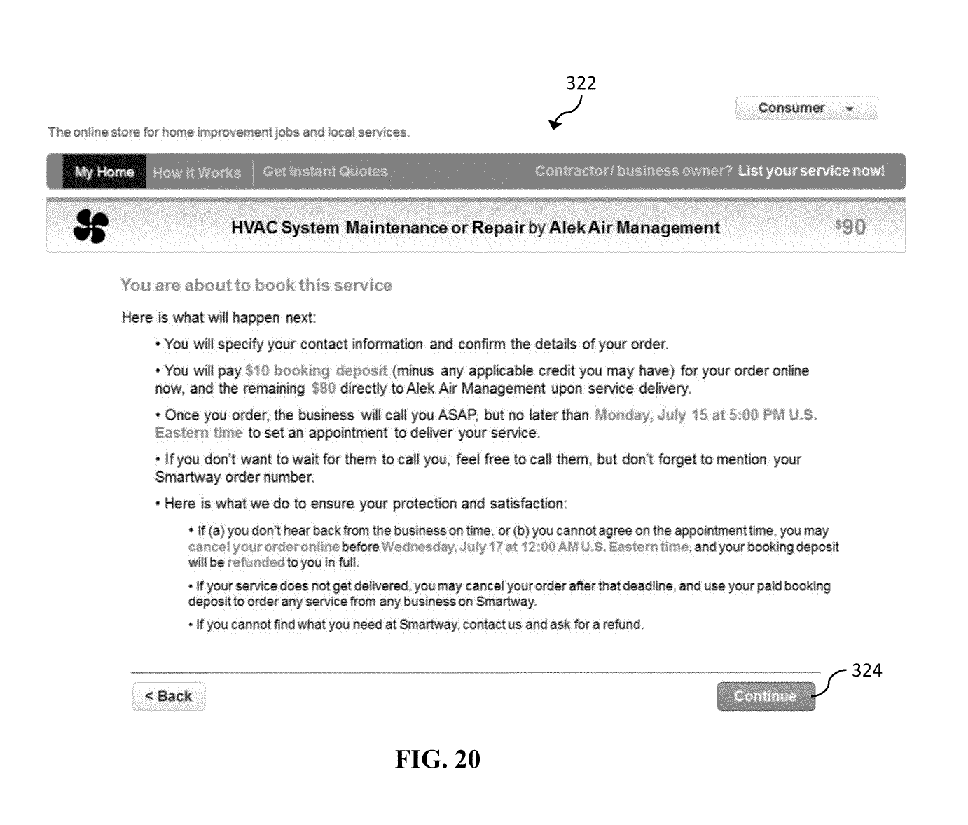

FIGS. 20-24 illustrate an example of a method for collecting purchase information and completing an order for a service request. It is noted that, while the method is depicted in FIGS. 20-24 as involving a plurality of webpages, one or more of the webpages can be omitted or replaced using information stored in server memory 14.

Referring collectively to FIGS. 1, and 20-24, the service request fulfillment engine 102 can present a webpage 322. The webpage 322 can provide instructions to the consumer regarding the ordering process, the financial terms of the order, and recourse for failure of service provider to provide ordered service. The webpage 322 can comprise a control 324 configured to receive input to advance the method. Responsive to input received by the control 324, the service request fulfillment engine 102 can present a webpage 326. The webpage 326 can comprise input fields 328 configured to receive a service address and contact information of the consumer 106. The webpage 326 can comprise a control 330 configured to receive input to advance the method. Responsive to input received by the control 330, the service request fulfillment engine 102 can present a webpage 332.

The webpage 332 can be configured to present information indicative of the details of the service for the consumer 106 to review and confirm. If the information is not correct, the consumer 106 can correct the information. For example, the webpage 332 can comprise a control 334 configured to receive input and to launch a correction method in response to the input. If the information is correct, the consumer can continue with the process. For example, the webpage 332 can comprise a control 336 configured to receive input to advance the method. Responsive to input received by the control 336, the service request fulfillment engine 102 can present a webpage 338. The webpage 338 can be configured to receive payment from the consumer 106 for services ordered. For example, the webpage 338 can comprise input fields 340 configured to receive payment information from the consumer 106. The webpage 338 can comprise a state change control 342 configured to finalize payment. Responsive to input received by the state change control 342, the service request fulfillment engine 102 can submit payment. Once the payment is submitted, the consumer 106 has finalized the order, which obligates the consumer to pay the quoted amount agreed to and obligates the service provider 118 to perform the service purchased. Accordingly, in some embodiments, in response to input received by the state change control 342, the service request fulfillment engine 102 can update the states of all of the quotes 302 (FIG. 17). After the order is finalized, the service request fulfillment engine 102 can present webpage 344 that is configured to provide confirmation information regarding the order.

In some embodiments, the service request fulfillment engine 102 can be configured to collect a booking deposit when the payment is submitted, i.e., the booking deposit can be charged to the consumer 106. The online marketplace 100 can retain the booking deposit as its fee for facilitating the order. The consumer 106 can pay the remainder of the quoted amount directly to the service provider 118. In one embodiment, the booking deposit can be ten percent of the quoted amount or ten dollars, whichever is greater. Alternatively, the service can be booked without any booking deposit.

Referring collectively to FIGS. 1, 4, and 17, the service request fulfillment engine 102 can automatically generate quotes 302, when a consumer 106 provides sufficient information for a service request. In some embodiments, the consumer 106 can view all quotes 302 generated by the service request fulfillment engine 102 substantially contemporaneously. Moreover, the quotes 302 can be generated in real-time. This is to say that once all required information is provided by the consumer 106, the service request fulfillment engine 102 can generate quotes 302 from all applicable service providers 118 and present the quotes 302 to the consumer 106 nearly instantaneously. As also described, the presented quotes 302 are customized to the consumer's service request.

In another example, the service request fulfillment engine 102 can be arranged to provide only a select or predetermined number of quotes 302. For example, the quotes 302 can be filtered according to a preference criteria such as, but not limited to, the ten least expensive quotes, quotes from the ten closest service providers, or quotes from service providers that have certain licenses or only positive consumer ratings. In some embodiments, the preference criteria can be preselected based upon input entered by the consumer 106.

Certain services can be arranged so that the quote for services is always a firm quote. For example, for services such as carpet installation based on square footage or a yearly service call for an HVAC system, the hours required to perform the service can be predicted by the service provider, which can lead to a firm quote and will bind the service provider to the agreement. Alternatively or additionally, the quote for services can be defined based upon service parameters that are predefined. That is, predefined quotes can be quotes that are generated from predefined service request parameters or predefined service requests.

Referring collectively to FIGS. 1, 3, 4, and 25, the service request fulfillment engine 102 can provide a webpage 346 configured to provide a plurality of quote objects 348. Each of the quote objects 348 can provide a quote summary indicative of one or more predefined quotes for a predefined standard service such as, but not limited to, replacement of 40-gallon gas water heater, installing a specific square footage of carpet, or the like. Each of the predefined quotes can be based upon predefined service parameters, i.e., the service parameters can be defined without requiring the consumer 106 to prepare a service request. For example, the service parameters can be defined by the service provider 118, or defined by the service request fulfillment engine 102 based upon previously finalized deals. In some embodiments, the service request fulfillment engine 102 can define the service parameters or enforce uniform standards for the service parameters. Specifically, the service parameters can be offered to the service providers 118 for acceptance. Each accepted set of service parameters can be utilized to define a predefined quote.

Each of the quote objects 348 can be configured to receive input from the consumer 106. Upon receiving the input with the quote object 348, the service request fulfillment engine 102 can automatically provide the predefined quotes for selection. In some embodiments, in response to the input received by the quote object 348, the service request fulfillment engine 102 can generate a plurality of predefined quotes using predefined service request parameters, instead of a service request prepared by the consumer 106. Alternatively or additionally, the predefined quotes can be generated in advance and retrieved from the server memory 14 in response to the input received by the quote object 348. Once generated, the predefined quotes can be provided in the substantially the same manner as the quotes 302 (FIG. 17). In some embodiments, the predefined quotes can be modified by the consumer 106 by adjusting one or more parameters. In further embodiments, the online marketplace 100 can define and enforce the uniform standards to operate as a platform for collaborative consumption of services. For example, upon receiving the input with the quote object 348, the service request fulfillment engine 102 can automatically dispatch the service provider 118 to the consumer 106. In one example, the service request fulfillment engine 102 can automatically select the service provider 118 to dispatch based upon availability, proximity to the consumer 106, or both.

The predefined quotes associated with the quote objects 348 can be filtered according to selection criteria. In some embodiments, the predefined quotes can be filtered based upon proximity to the consumer 106, i.e., the predefined quotes can be restricted to one or more geographic regions. Alternatively or additionally, the predefined quotes can be filtered based upon any of the parameters such as, for example, service category, service type, etc. In one embodiment, the webpage 346 can comprise a filter control 350 configured to receive input to filter the predefined quotes according to any parameter described herein.

Referring collectively to FIGS. 1, 3, and 17, for more complex services (e.g. HVAC install and replace), the quote 302 may rely on the accuracy of the information provided by the consumer 106. For example, the consumer 106 may provide details on an existing HVAC system, the size of the structure to be heated and cooled, the type of utilities available to facilitate the installation, etc. In such situations the quote 302 can be contingent on the consumer 106 providing accurate information. For example, if the consumer 106 wants to install a furnace that runs on natural gas to replace an electric heat pump, the consumer 106 may assert that there is a ready supply of natural gas at or near the location of the installation. To the extent this information is inaccurate and a natural gas line has to be run from a source to the location where the new furnace will be installed, the quote may need to be adjusted. In such occasions, the service provider 118 can have the right to reasonably adjust the quote 302 or cancel the quote 302. When the quote 302 is reasonably adjusted by the service provider 118, the consumer 106 can evaluate the adjustment before deciding whether to order the service from the service provider 118.

The online marketplace 100 can provide functionality to protect the consumer 106. For example, the online marketplace 100 can provide the consumer with the ability to cancel the order within a certain period of time (i.e., cancelation period). For example, the online marketplace 100 can provide for the consumer 106 to cancel an order before midnight of the day following the placement of the order. Such a decision may be based, for example, on the service provider 118 not contacting the consumer 106 in a timely fashion. In such a case, the booking deposit will not be charged to the consumer. The payment of the booking deposit can be arranged so that the amount of the booking deposit is not charged to the credit card of the consumer 106 until the end of any cancelation period. The online marketplace can provide for the consumer 106 to cancel the contract after the cancelation period if the consumer 106 is not satisfied with the work of the service provider 118. For example, if the service provider 118 does not begin the job on time or the work is subpar. In such an instance, any paid booking deposit can be retained for the consumer 106 as a credit toward future orders for services from any service provider.

If the service ordered is relatively expensive, the booking fee can be split between the consumer 106 and the service provider 118. For example, if a service is quoted at $7000.00, the consumer 106 can be charged a booking deposit of $50.00 and the service provider 118 can be charged a booking deposit of $650.00. The $700.00 total can be kept by the online marketplace 100 as a fee for facilitating the order of the service. At the completion of the service, the consumer 106 then pays the service provider 118 a sum of $6950.00. In other embodiments, the service provider 118 can establish its own payment policies that will be transparent to the consumer 106. For example, the service provider 118 may require 50% of payment upfront before beginning the job. The online marketplace 100 can display the payment policy of each service provider 118 to consumers 106. Thus, the payment policy can be known at the time a service order is placed with a service provider 118. However, the execution of the payment policies can be handled directly between the consumer 106 and service provider 118 outside the online marketplace 100.

As previously described, at the time of ordering of a service, the consumer 106 and service provider 118 can each be contractually bound to an agreement to perform and pay for the service. To facilitate such an arrangement, the quote 302 can explicitly define the fixed scope of the service, the fixed cost of the service, and any other terms required by the parties. Any inaccurate or incomplete information provided by the consumer 106 or the service provider 118 can result in an adjustment of the quote or a cancelation of the order.

The online marketplace 100 can also be arranged so that after the completion of the service, the consumer can provide feedback on the service provider 118. Such feedback can be stored by the online marketplace 100 and provided to subsequent consumers investigating that particular service provider 118.

As will be appreciated, questions presented to both the service provider and the consumer are a method by which the system can gather sufficient information to generate accurate quotes that can be relied upon by both service providers and consumers. The questions presented to service providers are designed to establish parameters that define the services a service provider is willing to render to consumers and the conditions under which the service provider is willing to render those services to consumers. Questions presented to consumers are designed to establish parameters that define the scope of a service request and the conditions under which the consumer is willing to order services from a service provider.

As illustrated in the figures, various graphic user interface features can be used to present questions to service providers and consumers to gather information to establish parameters. For example, as illustrated in FIG. 6, a list of check boxes 146 can be presented to a service provider to gather information to establish parameters such as: the service provider will offer quotes for residential service requests, commercial service requests, or both; the service provider will offer quotes for certain categories of hardware but not others; and so on. As illustrated in FIG. 8, text fields 162, 164 can be presented to a service provider to define the price it will charge for certain service activities such as hour of labor or certain commodities such as pound of refrigerant. A drop down list 166 can be presented to a service provider to define a start date relative to the confirmation of an order for services.

Referring collectively to FIGS. 3, 4, and 26, the service request fulfillment engine 102 can be configured to provide quotes directly to a service provider webpage 360. Specifically, a service provider 118 can control a service provider webpage 360 that is hosted via a service provider server 123. In some embodiments, the service provider webpage 360 can comprise one or more objects describing the service provider and a quote control 362 that is configured to receive input. Upon receiving input via the quote control 362, service provider webpage 360 can be configured to launch a quote widget 364 that communicates with the service request fulfillment engine 102, i.e., the service provider server 123 can be communicatively coupled to the one or more servers 104. The quote widget 364 can be configured to receive service request parameters and provide one or more quotes based upon service listing parameters of the service provider 118 associated with the service provider webpage 360, as described herein. Thus, the service provider webpage 360 can provide quotes from just one service provider 118 on the service provider webpage 360, which is controlled by the service provider 118.

Accordingly, the service provider webpage 360 can be a composite webpage that combines the quoting functionality of the quote widget 364 with visually perceptible elements controlled by the service provider 118. Since the quote widgets 364 provide quotes of the service provider 318 alone, the service provider webpage 360 can provide an additional channel to the online marketplace 100 for providing quotes. Quotes can be provided without directing the consumer 106 to the online marketplace 100 and providing the consumer 106 with quotes from competitors, thus allowing the service provider webpage 360 to retain control over the consumer 106.

Referring again to FIGS. 1, 3, and 4, with regard to service providers 118, the service request fulfillment engine 102 can be arranged to gather many service listing parameters regarding the technical capabilities of service providers and the business rules established by service providers regarding how services will be rendered. Each service provider 118 can be presented with a series of questions for each service it commits to providing to consumers 116 via the service request fulfillment engine 102. Below are five tables (Tables 1A through 1E) that list exemplary service listing parameters the service request fulfillment engine 102 can establish through information provided by the service provider 118 to define how a service provider will render services for installing or replacing an HVAC system.

TABLE 1A
General service listing parameters for a service provider offering
services for installing and replacing HVAC systems
SERVICE LISTING PARAMETERS FOR A SERVICE PROVIDER
General Parameters for Installation and Replacement of HVAC Systems

| Parameter Name | Parameter Description |
|---|---|
| StandardScope | Description of the standard project: what's included and not |
| | included into the price (same for all contractors) |
| ListingType | RegularSplit, HeatPump or MiniSplit |
| StatesLicensed | List of states where provider is licensed |
| LicenseInfo | License numbers and other details |
| CanPullPermit | Agree to bid on jobs where homeowner wants contractor to pull |
| | permit? (Yes, No) |
| PermitPullPrice | Pricing for pulling a permit |
| LaborVolumeDiscountLimit | Labor price after which a volume discount will apply |
| LaborVolumeDiscountPct | Discount % for any labor above the limit |
| EntireQuoteDiscount | Discount off entire quote price, % |
| ExtraLaborRate | Indicative hourly rate for any additional work |
| RefrigerantPrice | Indicative refrigerant price, per lb |
| PaymentTerms | Provider's payment terms |
| AdditionalTerms | Narrative description of any additional terms for this service |
| | from this business |
| LeadTime | How soon can this provider typically start on a job after |
| | receiving an order for this service (working days) |
| ServiceAreaCenter | Center of geogrphic area where provider offers this service |
| | (city/state or zip) |
| ServiceAreaRadius | Radius of geographic area where provider offers this service |
| | (miles) |
| QuoteType | What quotes should this listing generate: Tentative or Firm |

TABLE 1B
Parts service listing parameters for a service provider offering
services for installing and replacing HVAC systems
SERVICE LISTING PARAMETERS FOR A SERVICE PROVIDERS
Parts Parameters for Installation and Replacement of HVAC Systems

| Parameters Name | Parameter Description |
|---|---|
| RSHardwareVendors | Regular split HVAC hardware vendors that provider works with |
| | (e.g. York, Carrier) |
| RSWarrantyTerms | Regular split provider's warranty terms for jobs using hardware |
| | from each vendor |
| RSCondenserPricing | Regular split price sheet for A/C condenser hardware depending |
| | on capacity (tons) and efficiency (SEER), for each vendor |
| RSCoilPricing | Regular split price sheet for A/C coil hardware depending on |
| | capacity (tons) and efficiency (SEER), for each vendor |
| RSFurnacePricing | Regular split price sheet for gas furnace hardware depending on |
| | capacity (BTU) and efficiency (%), for each vendor |
| HPOutdoorUnitPricing | Heat pump price sheet for outdoor unit hardware depending on |
| | capacity (tons) and efficiency (SEER), for each vendor |
| HPIndoorUnitPricing | Heat pump price sheet for indoor unit hardware depending on |
| | capacity (tons) and efficiency (SEER), for each vendor |
| MSOutdoorUnitPricing | Mini-split price sheet for outdoor unit hardware depending on |
| | capacity (tons) and efficiency (SEER), for each vendor |
| MSIndoorUnitPricing | Mini-split price sheet for indoor unit hardware depending on |
| | capacity (tons) and efficiency (SEER), for each vendor |

TABLE 1C
Regular split labor service listing parameters for service provider
offering services for installing and replacing HVAC systems
SERVICE LISTING PARAMETERS FOR A SERVICE PROVIDERS
Regular Split Labor Parameters for Installation
and Replacement of HVAC Systems

| Parameters Name | Parameter Description |
|---|---|
| RSCondenserInstallPrice | Pricing for new installation of condenser depending on location |
| | (Ground, Roof) |
| RSCondenserReplacePrice | Pricing for replacement of condenser depending on location |
| | (Ground, Roof) |
| RSCoilInstallPrice | Pricing for new installation of coil depending on location |
| | (Basement, Closet, Attic) |
| RSCoilReplacePrice | Pricing for replacement of coil depending on location |
| | (Basement, Closet, Attic) |
| RSFurnaceInstallPrice | Pricing for new installation of furnace depending on location |
| | (Basement, Closet, Attic) |
| RSFurnaceReplacePrice | Pricing for replacement of furnace depending on location |
| | (Basement, Closet, Attic) |
| RSRefrigerantLinesPrice | Pricing (labor + materials) for running refrigerant line set |
| | between condenser and coil, depending on scenario (Normal, |
| | Complex) |
| RSCondensateLinePrice | Pricing (labor + materials) for running condensate drain line, |
| | depending on scenario (Normal, Complex) |
| RSAirPipesLinePrice | Pricing (labor + materials) for running air intake/exhaust pipes |
| | (for 90% + efficiency furnaces), depending on scenario (Normal, |
| | Complex) |
| RSGasLinePrice | Pricing (labor + materials) for running gas line between meter |
| | and furnace, depending on line length (<50 ft, 50-100 ft, >100 ft) |

TABLE 1D
Heat pump labor service listing parameters for service Provider
offering services for installing and replacing HVAC systems
SERVICE LISTING PARAMETERS FOR SERVICE PROVIDERS
Heat Pump Labor Parameters for Installation
and Replacement of HVAC Systems

| Parameters Name | Parameter Description |
|---|---|
| HPOutdoorInstallPrice | Pricing for new installation of outdoor unit depending on |
| | location (Ground, Roof) |
| HPOutdoorReplacePrice | Pricing for replacement of outdoor unit depending on location |
| | (Ground, Roof) |
| HPIndoorInstallPrice | Pricing for new installation of indoor unit depending on location |
| | (Basement, Closet, Attic) |
| HPIndoorReplacePrice | Pricing for replacement of indoor unit depending on location |
| | (Basement, Closet, Attic) |
| HPRefrigerantLinesPrice | Pricing (labor + materials) for running refrigerant line set |
| | between units, depending on scenario (Normal, Complex) |
| HPCondensateLinePrice | Pricing (labor + materials) for running condensate drain line, |
| | depending on scenario (Normal, Complex) |

TABLE 1E
Mini-split labor service listing parameters for service provider
offering services for installing and replacing HVAC systems
SERVICE LISTING PARAMETERS FOR SERVICE PROVIDERS
Mini-Split Labor Parameters for Installation
and Replacement of HVAC Systems

| Parameters Name | Parameter Description |
|---|---|
| MSOutdoorInstallPrice | Pricing for new installation of outdoor unit |
| MSOutdoorReplacePrice | Pricing for replacement of outdoor unit |
| MSIndoorInstallPrice | Pricing for new installation of indoor unit |
| MSIndoorReplacePrice | Pricing for replacement of indoor unit |
| MSWirePrice | Pricing (labor + materials) for running an electric wire to |
| | outdoor unit, depending on scenario (Normal, Complex) |

In one embodiment, the five tables above (Tables 1A-1E) define the service listing parameters that can be used by the service request fulfillment engine 102 to generate real-time quotes for consumers 106 that have submitted service requests for installation or replacement of an HVAC system. Table 1A defines general service listing parameters such as the type of systems (regular split, heat pumps, and/or mini-split) installed and replaced by the service provider 118; in which states the service provider 118 is licensed; whether the service provider is willing to file for and obtain required local permits; and many more. Table 1B defines the parts service listing parameters such as the hardware vendors the service provider 118 works with; warranty terms for the hardware; price for condensers, coils, furnace, etc. Tables 1C-1E define labor costs for installing or replacing various HVAC systems.

Although Tables 1A-1E include many service listing parameters, it will be appreciated that the service request fulfillment engine 102 can provide a service provider 118 with a graphic user interface that uses features such as check boxes, radio buttons, fill-in text boxes, drop down lists, etc. to efficiently gather information from a service provider 118 to define values for the service listing parameters. This is to say that the service request fulfillment engine 102 can be arranged to gather all the information it needs to determine values for the service listing parameters without the need to present the service provider 118 with a laborious and time-consuming question and answer process.

With regard to consumers 106, the service request fulfillment engine 102 can be arranged to gather service request parameters regarding the requirements of a service request and the requirements established by consumers when ordering services. Below, Table 2 lists service request parameters the service request fulfillment engine 102 can establish to define a service request from a consumer 106 for installing or replacing an HVAC system.

TABLE 2
Service Request Parameters for consumer service requests
for installation and replacement of HVAC systems
SERVICE REQUEST PARAMETERS FOR CONSUMER
Parameters for Installation and Replacement of HVAC Systems

| Parameter Name | Parameter Description |
|---|---|
| ServiceLocation | Where the service is needed (city/state or zip) |
| SystemType | What kind of system to install/replace |
| | (RegularSplit, HeatPump or MiniSplit) |
| RequestType | What needs to be done |
| | (FullNewInstall, FullReplace, IndividialUnits) |
| RSUnitsToReplace | Regular split units to replace: zero or more from the following: |
| | Condenser, Coil, Furnace |
| RSUnitsToInstall | Regular split units for new install: zero or more from the |
| | following: Condenser, Coil, Furnace |
| HPUnitsToReplace | Heat pump units to replace: zero or more from the following: |
| | Outdoor, Indoor |
| HPUnitsToInstall | Heat pump units to new install: zero or more from the following: |
| | Outdoor, Indoor |
| MSUnitsToReplace | Mini-split units to replace: zero or more from the following: |
| | Outdoor, Indoor |
| MSUnitsToInstall | Mini-split units to new install: zero or more from the following: |
| | Outdoor, Indoor |
| RSNeedGasLine | Should contractor run the gas line for gas furnace? (Yes, No) |
| RSGasLineLength | Needed gas line length (<50 ft, 50-100 ft, >100 ft) |
| RSDesiredCoolingEfficiency | Desired cooling efficiency for regular split (SEER) |
| RSDesiredHeatingEfficiency | Desired heating efficiency for regular split (%) |
| HPDesiredEfficiency | Desired efficiency for heat pump (SEER) |
| MSDesiredEfficiency | Desired efficiency for mini-split (SEER) |
| RSOutdoorUnitLocation | Outdoor unit location for regular split (Ground, Roof) |
| RSIndoorUnitLocation | Indoor unit location for regular split (Basement, Closet, Attic) |
| HPOutdoorUnitLocation | Outdoor unit location for heat pump (Ground, Roof) |
| HPIndoorUnitLocation | Indoor unit location for heat pump (Basement, Closet, Attic) |
| NeedPermit | Must contractor pull a permit? (Yes, No) |
| RSCoolingCapacity | Cooling capacity for regular split (tons) |
| RSHeatingCapacity | Heating capacity for regular split (BTU) |
| HPCapacity | Capacity for heat pump (tons) |
| MSCapacity | Capacity for mini-split (BTU/tons) |
| HomeSquareFootage | Heated/cooled square footage, for calculation of capacity (sq ft) |
| InsulationScenario | Home insulation condition, for capacity calculation (Good, |
| | Normal) |
| RefrigerantLinesScenario | Complexity of running refrigerant lines between RS or HP units |
| | (Normal, Complex) |
| DrainLineScenario | Complexity of running condensate drain line for RS or HP |
| | (Normal, Complex) |
| RSAirPipesScenario | Complexity of running air pipes for RS high-efficiency furnace |
| | (Normal, Complex) |
| MSWireScenario | Complexity of running electric wire to MS outdoor unit (Normal, |
| | Complex) |
| ExtraDetails | Extra details for request |
| Photos | Photos attached by consumer to request |
| PhotoDescriptions | Descriptions for photos attached by consumer to request |

In one embodiment, Table 2 defines the service request parameters that can be used by the service request fulfillment engine 102 to generate a real-time quote for a consumer 106 that has submitted a service request for installation of replacement of an HVAC system. Table 2 includes service request parameters; however, similar to the description above, it will be appreciated that the service request fulfillment engine 102 can provide a consumer 106 with a graphic user interface that uses objects or controls such as check boxes, radio buttons, fill-in text boxes, drop down lists, etc. to efficiently gather information from a consumer 106 to define values for service request parameters.

While the service request fulfillment engine 102 can be arranged to generally rely on knowledgeable service providers 118 to successfully provide information to populate Tables 1A-1E, consumers 106 can be less knowledgeable. For example, a homeowner that needs a new HVAC system may not know or understand all the terminology used in the HVAC industry or the general requirements for HVAC systems. It will be appreciated that a graphic user interface can be designed to lead consumers 106 through questions to gather the service request parameters for the service request fulfillment engine 102 to deduce certain parameter values. For example, two of the service request parameters of Table 2 is “RSCoolingCapacity” and “RSHeatingCapacity.” RSCoolingCapacity is the cooling capacity in tons required for a regular split installation, and RSHeatingCapacity is the heating capacity in BTUs required for a regular split installation. While a knowledgeable consumer 106 may be able to provide the capacities directly, many consumers may not know the required capacities. In this case, the service request fulfillment engine 102 can ask the consumer for information, such as the square footage of the home (i.e., HomeSquareFootage in Table 2), from which to calculate the required cooling or heating capacities. Furthermore, even if the consumer 106 provides values for the capacities, the service request fulfillment engine 102 can compare those values to a value calculated from the square footage of the home to insure that the consumer 106 did not make an error in entering the capacities.

Table 3 below is an example of a list of service listing parameters for service providers 118 that can be used by the service request fulfillment engine 102 to generate real-time quotes for consumers 106 submitting service requests for maintenance and repair of an HVAC system. Table 4 below is an example of a list of service request parameters for consumers 106 that can be used by the service request fulfillment engine 102 to generate a real-time quote for maintenance and repair of an HVAC system.

TABLE 3
Parameters for service providers offering services
to maintain and repair HVAC systems
SERVICE LISTING PARAMETERS FOR SERVICE PROVIDERS
Parameters for Maintenance and Repair of HVAC Systems

| Parameter Name | Parameter Description |
|---|---|
| StandardScope | Description of the standard project: what's included and |
| | not included into the price (same for all contractors) |
| StatesLicensed | List of states where provider is licensed |
| LicenseInfo | License numbers and other details |
| EntireQuoteDiscount | Discount off entire quote price, % |
| ExtraLaborRate | Indicative hourly rate for any additional work |
| RefrigerantPrice | Indicative refrigerant price, per lb |
| AdditionalTerms | Narrative description of any additional terms for this |
| | service from this business |
| LeadTime | How soon can this provider typically start on a job after |
| | receiving an order for this service (working days) |
| ServiceAreaCenter | Center of geo area where provider offers this service |
| | (city/state or zip) |
| ServiceAreaRadius | Radius of geo area where provider offers this service |
| | (miles) |
| QuoteType | What quotes should this listing generate: Tentative or |
| | Firm |
| ServiceResidences | Provider services residences? (Yes, No) |
| ServiceBusinesses | Provider services businesses? (Yes, No) |
| SystemTypesServiced | System types serviced. One or more of the following: |
| | CentralCooling, CentralHeating, DuctlessMiniSplit, |
| | Window AC, AirQuality, Refrigeration |
| HeatingSourcesServiced | Central heating sources the provider works with. One or |
| | more of the following: NaturalGas, Propane, Oil, |
| | ElectricHeatPump, ElectricNotHeatPump, |
| | HybridGasElectric |
| HeatingMediumServiced | Central heating medium the provider works with. One or |
| | more of the following: ForcedAir, Steam, Hot Water |
| RooftopServiced | Consider service requests for rooftop units? (Yes, |
| | YesIfRoofAccess, No) |
| ResMaintCallPrice | Residential maintenance call price, $ |
| ComMaintCallPrice | Commercial maintenance call price, $ |
| ResDiagnosticsCallPrice | Residential diagnostics call price, $ |
| ComDiagnosticsCallPrice | Commercial diagnostics call price, $ |

TABLE 4
Parameters for consumer service requests for
maintenance and repair of HVAC Systems
SERVICE REQUEST PARAMETERS FOR CONSUMER
Parameters for Maintenance and Repair of HVAC Systems

| Parameter name | Parameter description |
|---|---|
| ServiceLocation | Where the service is needed (city/state or zip) |
| SystemType | What kind of system needs attention |
| | (CentralCooling, CentralHeating, DuctlessMiniSplit, |
| | WindowAC, AirQuality, Refrigeration) |
| RequestType | What needs to be done |
| | (Maintenance, Diagnostics) |
| HeatingSource | Central heating source (if SystemType = |
| | CentralHeating): one of the following: NaturalGas, |
| | Propane, Oil, ElectricHeatPump, |
| | ElectricNotHeatPump, HybridGasElectric |
| HeatingMedium | Central heating medium (if SystemType = |
| | CentralHeating): one of the following: ForcedAir, |
| | Steam, HotWater |
| IsRooftop | Is the unit located on the roof? (YesWithAccess, |
| | YesWithoutAccess, No) |
| NatureOfProblem | Nature of problem (if RequestType = Diagnostics): |
| | one of the following: IndoorUnitNotRunning, |
| | OutdoorUnitNotRunning, PoorPerformance, |
| | RunsConstantly, CyclesTooOften, NoColdAir, |
| | NoWarmAir, Leak, Iced, GasSmell, ColdRadiators, |
| | Other |
| ProblemDescription | If NatureOfProblem = Other |
| IsUrgent | Is this service urgent? (Yes, No) |
| LocationType | Service location type (Residence, Business) |
| ExtraDetails | Extra details for request |
| Photos | Photos attached by consumer to request |
| PhotoDescriptions | Descriptions for photos attached by consumer to |
| | request |

Table 5 below is an example of a list of service listing parameters for service providers 118 that can be used by the service request fulfillment engine 102 to generate real-time quotes for consumers 106 submitting service requests for water heater installation and repair services. Table 6 below is an example of a list of service request parameters for consumers 106 that can be used by the service request fulfillment engine 102 to generate a real-time quote for water heater installation and repair services.

TABLE 5
Service Listing Parameters for service providers offering
services for water heater installation or replacement
SERVICE LISTING PARAMETERS FOR SERVICE PROVIDERS
Parameters for Water Heater Installation of Replacement

| Parameter name | Parameter description |
|---|---|
| StandardScope | Description of the standard project: what's included and |
| | not included into the price (same for all contractors) |
| StatesLicensed | List of states where provider is licensed |
| LicenseInfo | License numbers and other details |
| EntireQuoteDiscount | Discount off entire quote price, % |
| PaymentTerms | Provider's payment terms |
| AdditionalTerms | Narrative description of any additional terms for this |
| | service from this business |
| LeadTime | How soon can this provider typically start on a job after |
| | receiving an order for this service (working days) |
| ServiceAreaCenter | Center of geo area where provider offers this service |
| | (city/state or zip) |
| ServiceAreaRadius | Radius of geo area where provider offers this service |
| | (miles) |
| QuoteType | What quotes should this listing generate: Tentative or |
| | Firm |
| WHHardwareVendors | Water heater hardware vendors that provider works with |
| | (e.g. Rheem, Bradford White) |
| WHWarrantyTerms | Provider's warranty terms for jobs using hardware from |
| | each vendor |
| WHHardwarePricing | Price sheet for WH hardware depedning on capacity |
| | (gals) and fuel source (Gas, Oil, Electric, Propane), for |
| | each vendor |
| WHLaborPricing | Price sheet for WH installation labor depending on type |
| | of replacement (Gas to Gas, Oil to Gas, etc.) and location |
| | of the heater (Basement, Closet, Crawl space, etc.) |
| CommercialJobs | Does provider do commercial jobs? (Yes, No) |
| CommercialJobExtraFee | Surcharge for commercial jobs |
| UrgentJobs | Does provider do urgent jobs? (Yes, No) |
| UrgentJobExtraFee | Surcharge for urgent jobs |
| CanPullPermit | Agree to bid on jobs where homeowner wants contractor |
| | to pull permit? (Yes, No) |
| PermitPullPrice | Pricing for pulling a permit |

TABLE 6
Service Request Parameters for consumer service requests
for water heater installation or replacement
SERVICE REQUEST PARAMETERS FOR CONSUMER
Parameters for Water Heater Installation of Replacement

| Parameter name | Parameter description |
|---|---|
| LocationType | Service location type (Residence, Business) |
| ServiceLocation | Where the service is needed (city/state or zip) |
| ExtraDetails | Extra details for request |
| Photos | Photos attached by consumer to request |
| PhotoDescriptions | Descriptions for photos attached by consumer to request |
| IsUrgent | Is this service urgent? (Yes, No) |
| ExistingHeaterType | Gas; Oil; Electric; Propane; HybridElectricHeatPump |
| ExistingHeaterSize | 30; 40; 50; 60; 75 gal. |
| ExistingHeaterHeight | Inches |
| ExistingHeaterDiameter | Inches |
| ExistingHeaterLocation | Basement; Closet; CrawlSpace; Attic; Garage |
| ClosetHeight | Inches |
| ClosetWidth | Inches |
| ClosetDepth | Inches |
| Photos | Photos attached by consumer to request |
| DesiredHeaterSize | 30; 40; 50; 60; 75 gal. |
| DesiredHeaterType | Gas; Oil; Electric; Propane; HybridElectricHeatPump |

Table 7 below is an example of a list of service listing parameters for service providers 118 that can be used by the service request fulfillment engine 102 to generate real-time quotes for consumers 106 submitting service requests for flooring services. Table 8 below is an example of a list of service request parameters for consumers 106 that can be used by the service request fulfillment engine 102 to generate a real-time quote for flooring services.

TABLE 7
Service Listing Parameters for service providers
offering flooring services
SERVICE LISTING PARAMETERS FOR SERVICE PROVIDERS
Parameters for Flooring

| Parameter name | Parameter description |
|---|---|
| StandardScope | Description of the standard project: what's included |
| | and not included into the price (same for all |
| | contractors) |
| StatesLicensed | List of states where provider is licensed |
| LicenseInfo | License numbers and other details |
| EntireQuoteDiscount | Discount off entire quote price, % |
| PaymentTerms | Provider's payment terms |
| WarrantyTerms | Provider's warranty terms |
| AdditionalTerms | Narrative description of any additional terms for this |
| | service from this business |
| LeadTime | How soon can this provider typically start on a job |
| | after receiving an order for this service (working |
| | days) |
| ServiceAreaCenter | Center of geo area where provider offers this service |
| | (city/state or zip) |
| ServiceAreaRadius | Radius of geo area where provider offers this service |
| | (miles) |
| QuoteType | What quotes should this listing generate: Tentative or |
| | Firm |
| CarpetInstallationPricing | Price per sqft, residential and commercial |
| CarpetRemovalPricing | Price per sqft, residential and commercial |
| LaminateInstallationPricing | Price per sqft, residential and commercial |
| LaminateRemovalPricing | Price per sqft, residential and commercial |
| HardwoodInstallationPricing | Price per sqft, residential and commercial |
| HardwoodRemovalPricing | Price per sqft, residential and commercial |
| HardwoodRefinishPricing | Price per sqft, residential and commercial |
| PaddingInstallationPricing | Price per sqft, residential and commercial |
| PaddingRemovalPricing | Price per sqft, residential and commercial |
| ProjectsWithStaircases | Does the contractor bid on projects with staircases? |
| | Yes/No |
| SCCarpetInstallationPricing | Price per step, residential and commercial |
| SCCarpetRemovalPricing | Price per step, residential and commercial |
| SCLaminateInstallationPricing | Price per step, residential and commercial |
| SCLaminateRemovalPricing | Price per step, residential and commercial |
| SCHardwoodInstallationPricing | Price per step, residential and commercial |
| SCHardwoodRemovalPricing | Price per step, residential and commercial |
| SCHardwoodRefinishPricing | Price per step, residential and commercial |
| MoveFurniture | Does the contractor move heavy furniture? Yes/No |
| MoveFurnitureExtraFee | Extra fee for moving furniture, per piece |
| ShoeMoldingPricing | Quarter round/shoe molding installation price (labor, |
| | per linear ft) |
| TransitionMoldingPricing | Transition molding installation (labor, per piece) |

TABLE 8
Service Request Parameters for consumer service
requests for flooring services
SERVICE REQUEST PARAMETERS FOR CONSUMER
Parameters for Flooring

| Parameter name | | Parameter description |
|---|---|---|
| LocationType | | Service location type (Residence, Business) |
| ServiceLocation | | Where the service is needed (city/state or zip) |
| ExtraDetails | | Extra details for request |
| Photos | | Photos attached by consumer to request |
| PhotoDescriptions | | Descriptions for photos attached by consumer to request |
| Rooms | | Number of rooms where flooring is needed |
| Hallways | | Number of hallways where flooring is needed |
| Closets | | Number of closets where flooring is needed |
| Staircases | | Number of staircases where flooring is needed |
| TransMoldings | | Number of transition moldings to install |
| RoomDescriptions | | Description for each room; parameters are below |
| | Area | Square footage of the room |
| | Width | Width of the room, ft |
| | Length | Length of the room, ft |
| | ExistingFloor | None, Carpet, Laminate, Hardwood |
| | NewFloor | Carpet, Laminate, Hardwood |
| | RefinishHardwood | If the present floor is hardwood, should it be just |
| | | refinished? Yes/No |
| | InstallShoeMolding | Install shoe molding here? Yes/No |
| | FurnitureToMove | How many pieces of heavy furniture should the |
| | | contractor move in this area? |
| HallwayDescriptions | | Description for each hallway; parameters are same as for |
| | | rooms |
| ClosetDescriptions | | Description for each closet; parameters are same as for |
| | | rooms |
| StaircaseDescriptions | | Description for each staircase; parameters are below |
| | SCSteps | Number of steps |
| | SCExistingMaterial | None, Carpet, Laminate, Hardwood |
| | SCNewMaterial | Carpet, Laminate, Hardwood |
| | RefinishHardwood | If the present material is hardwood, should it be just |

refinished? Yes/No

Table 9 below is an example of a list of service listing parameters for service providers 118 that can be used by the service request fulfillment engine 102 to generate real-time quotes for consumers 106 submitting service requests for roofing services. Table 10 below is an example of a list of service request parameters for consumers 106 that can be used by the service request fulfillment engine 102 to generate a real-time quote for roofing services.

TABLE 9
Service Listing Parameters for service providers
offering roofing services
SERVICE LISTING PARAMETERS FOR SERVICE PROVIDERS
Parameters for Roofing

| Parameter name | Parameter description |
|---|---|
| StandardScope | Description of the standard project: what's included |
| | and not included into the price (same for all |
| | contractors) |
| StatesLicensed | List of states where provider is licensed |
| LicenseInfo | License numbers and other details |
| EntireQuoteDiscount | Discount off entire quote price, % |
| PaymentTerms | Provider's payment terms |
| WarrantyTerms | Provider's warranty terms |
| AdditionalTerms | Narrative description of any additional terms for this |
| | service from this business |
| LeadTime | How soon can this provider typically start on a job |
| | after receiving an order for this service (working days) |
| ServiceAreaCenter | Center of geo area where provider offers this service |
| | (city/state or zip) |
| ServiceAreaRadius | Radius of geo area where provider offers this service |
| | (miles) |
| QuoteType | What quotes should this listing generate: Tentative or |
| | Firm |
| TearOffPricing | Price to tear off one layer of existing roof, per square |
| 30YearShinglePricing | Price to install 30-year asphalt shingles, labor + |
| | materials, per square |
| 50YearShinglePricing | Price to install 50-year asphalt shingles, labor + |
| | materials, per square |
| SteelPricing | Price to install steel roof, labor + materials, per square |
| AluminumPricing | Price to install aluminum roof, labor + materials, per |
| | square |
| CopperPricing | Price to install copper roof, labor + materials, per |
| | square |
| ArtificialSlatePricing | Price to install artificial slate roof, labor + materials, |
| | per square |
| NaturalSlatePricing | Price to install natural slate roof, labor + materials, per |
| | square |
| WoodShinglePricing | Price to install wood shingle roof, labor + materials, |
| | per square |
| WoodShakePricing | Price to install wood shake roof, labor + materials, per |
| | square |
| ElastomericPricing | Price to install elastomeric roof, labor + materials, per |
| | square |
| EPDMPricing | Price to install EPDM roof, labor + materials, per |
| | square |
| TPOPricing | Price to install TPO roof, labor + materials, per square |
| FiberglassPricing | Price to install fiberglass roof, labor + materials, per |
| | square |
| TorchdownPricing | Price to install torchdown roof, labor + materials, per |
| | square |
| TorchdownSCPricing | Price to install torchdown roof with silver coating, |
| | labor + materials, per square |
| NonWalkableFee | Extra fee for a non-walkable roof (pitch 8+), per square |
| ClosedValleyFee | Extra fee per closed valley |
| OpenValleyFee | Extra fee per open valley |
| DormerFee | Extra fee per dormer |
| ChimneyFee | Extra fee per chimney |
| ChimneyCFFee | Extra fee per chimney counter flashing |
| SkylightFee | Extra fee per skylight |
| RidgeVentFee | Extra fee for ridge vent, per ft |
| PermitPullPrice | Pricing for pulling a permit |
| PlywoodFee | Extra fee for plywood replacement, per sq. ft. |
| PlankingFee | Extra fee for planking replacement, per sq. ft. |

TABLE 10
Service Request Parameters for consumer service
requests for roofing services
SERVICE REQUEST PARAMETERS FOR CONSUMER
Parameters for Roofing

| Parameter name | Parameter description |
|---|---|
| LocationType | Service location type (Residence, Business) |
| ServiceLocation | Where the service is needed (city/state or zip) |
| ExtraDetails | Extra details for request |
| Photos | Photos attached by consumer to request |
| PhotoDescriptions | Descriptions for photos attached by consumer to request |
| HomeAddress | To pull pictures of the home (top view and street view) |
| | from Google Maps |
| RequestType | What needs to be done |
| | (Replace roof, Overlay existing roof) |
| Layers | How many roof layers are there now |
| GroundFloorArea | Size of the ground floor, sq ft |
| GroundFloorLength | Length of the ground floor, ft |
| GroundFloorWidth | Width of the ground floor, ft |
| RoofPitch | Roof pitch factor |
| RoofSize | Size of roof in roofing squares, may be calculated from |
| | parameters above or entered manually |
| NewRoofType | Asphalt, Metal, Slate, Wood, Flat |
| NewRoofMaterial | 30 Year Asphalt Shingles, 50 Year Asphalt Shingles, |
| | Steel, Aluminum, etc. (see listing params) |
| Dormers | Number of dormers |
| Chimneys | Number of chimneys |
| Skylights | Number of skylights |
| Valleys | Number of valleys |
| RidgeVent | Need ridge vent? Yes/No |
| ContractorGetsPermit | Yes/No |

Table 11 below is an example of a list of service listing parameters for service providers 118 that can be used by the service request fulfillment engine 102 to generate real-time quotes for consumers 106 submitting service requests for interior painting services. Table 12 below is an example of a list of service request parameters for consumers 106 that can be used by the service request fulfillment engine 102 to generate a real-time quote for interior painting services.

TABLE 11
Service Listing Parameters for service providers
offering interior painting services
SERVICE LISTING PARAMETERS FOR SERVICE PROVIDERS
Parameters for Interior Painting

| Parameter name | Parameter description |
|---|---|
| StandardScope | Description of the standard project: what's included |
| | and not included into the price (same for all |
| | contractors) |
| StatesLicensed | List of states where provider is licensed |
| LicenseInfo | License numbers and other details |
| EntireQuoteDiscount | Discount off entire quote price, % |
| PaymentTerms | Provider's payment terms |
| WarrantyTerms | Provider's warranty terms |
| AdditionalTerms | Narrative description of any additional terms for this |
| | service from this business |
| LeadTime | How soon can this provider typically start on a job |
| | after receiving an order for this service (working days) |
| ServiceAreaCenter | Center of geo area where provider offers this service |
| | (city/state or zip) |
| ServiceAreaRadius | Radius of geo area where provider offers this service |
| | (miles) |
| QuoteType | What quotes should this listing generate: Tentative or |
| | Firm |
| CommercialJobs | Does provider do commercial jobs? (Yes, No) |
| DecorativePainting | Does provider do decorative painting? (Yes, No) |
| NewSingleColorPricing | Labor price for new single color painting, for |
| | residential and commercial, below and above the 8 ft |
| | mark, per sq ft |
| RefreshPricing | Labor price for refreshing existing single color, for |
| | residential and commercial, below and above the 8 ft |
| | mark, per sq ft |
| DecorativePricing | Labor price for faux finish or texture coating, for |
| | residential and commercial, below and above the 8 ft |
| | mark, per sq ft |
| CeilingPricing | Labor price for ceiling painting, for residential and |
| | commercial, per sq ft |
| ExtraColorFee | Surcharge for each extra color in a room, per sqft of |
| | total room wall area, residential and commercial |
| MinorSpacklingFee | Extra fee for minor drywall spackling, per room, |
| | residential and commercial |
| MajorSpacklingFee | Extra fee for major drywall spackling, per sqft of total |
| | room wall area, residential and commercial |
| TrimFee | Extra fee for trim/molding/baseboard painting, per |
| | linear ft, residential and commercial |
| DoorFee | Extra fee per painted door, residential and commercial |
| WindowFee | Extra fee per painted window, residential and |
| | commercial |
| MoveFurniture | Does the contractor move heavy furniture? Yes/No |
| MoveFurnitureExtraFee | Extra fee for moving furniture, per piece |

TABLE 12
Service Request Parameters for consumer service
requests for interior painting services
SERVICE REQUEST PARAMETERS FOR CONSUMER
Parameters for Interior Painting

| Parameter name | | Parameter description |
|---|---|---|
| LocationType | | Service location type (Residence, Business) |
| ServiceLocation | | Where the service is needed (city/state or zip) |
| ExtraDetails | | Extra details for request |
| Photos | | Photos attached by consumer to request |
| PhotoDescriptions | | Descriptions for photos attached by consumer to request |
| Rooms | | Number of rooms where painting is needed |
| Hallways | | Number of hallways where painting is needed |
| Closets | | Number of closets where painting is needed |
| Kitchens | | Number of kitchens where painting is needed |
| Bathrooms | | Number of bathrooms where painting is needed |
| RoomDescriptions | | Description for each room; parameters are below |
| | Length | ft |
| | Width | ft |
| | CeilingHeight | ft |
| | PaintingType | Paint in new colors, Refresh existing colors, Faux finish |
| | | or texture coating |
| | Spackling | None, Minor, Major |
| | NumColors | Number of colors to use for this room |
| | PaintCeiling | Yes/No |
| | PaintBaseboard | Yes/No |
| | PaintChairRailMolding | Yes/No |
| | PaintCrownMolding | Yes/No |
| | NumDoors | Number of doors to paint |
| | NumWindows | Number of windows to paint |
| | FurniturePieces | How many furniture pieces to move |

| | |
|---|---|
| HallwayDescriptions | Description for each hallway; parameters are same as for |
| | rooms |
| Closets | Description for each closet; parameters are same as for |
| | rooms |
| Kitchens | Description for each kitchen; parameters are same as for |
| | rooms |
| Bathrooms | Description for each bathroom; parameters are same as |
| | for rooms |

Table 13 below is an example of a list of service listing parameters for service providers 118 that can be used by the service request fulfillment engine 102 to generate real-time quotes for consumers 106 submitting service requests for exterior painting services. Table 14 below is an example of a list of service request parameters for consumers 106 that can be used by the service request fulfillment engine 102 to generate a real-time quote for exterior painting services.

TABLE 13
Service Listing Parameters for service providers
offering exterior painting services
SERVICE LISTING PARAMETERS FOR SERVICE PROVIDERS
Parameters for Exterior Painting

| Parameter name | Parameter description |
|---|---|
| StandardScope | Description of the standard project: what's |
| | included and not included into the price (same |
| | for all contractors) |
| StatesLicensed | List of states where provider is licensed |
| LicenseInfo | License numbers and other details |
| EntireQuoteDiscount | Discount off entire quote price, % |
| PaymentTerms | Provider's payment terms |
| WarrantyTerms | Provider's warranty terms |
| AdditionalTerms | Narrative description of any additional terms for |
| | this service from this business |
| LeadTime | How soon can this provider typically start on a |
| | job after receiving an order for this service |
| | (working days) |
| ServiceAreaCenter | Center of geo area where provider offers this |
| | service (city/state or zip) |
| ServiceAreaRadius | Radius of geo area where provider offers this |
| | service (miles) |
| QuoteType | What quotes should this listing generate: |
| | Tentative or Firm |
| CommercialJobs | Does provider do commercial jobs? (Yes, No) |
| NewColorPricing | Labor + matarials price for new color painting, |
| | for residential and commercial, per sq ft |
| RefreshPricing | Labor + matarials price for refreshing existing |
| | color, for residential and commercial, per sq ft |
| DoorFee | Extra fee per painted door, residential and |
| | commercial |
| WindowFee | Extra fee per painted window, residential and |
| | commercial |
| PaintBrand | Paint brand the contractor typically uses |

TABLE 14
Service Request Parameters for consumer service
requests for exterior painting services
SERVICE REQUEST PARAMETERS FOR CONSUMER
Parameters for Exterior Painting

| Parameter name | | Parameter description |
|---|---|---|
| LocationType | | Service location type (Residence, Business) |
| ServiceLocation | | Where the service is needed (city/state or zip) |
| ExtraDetails | | Extra details for request |
| Photos | | Photos attached by consumer to request |
| PhotoDescriptions | | Descriptions for photos attached by consumer to |
| | | request |
| Walls | | Number of walls to be painted |
| Doors | | Number of doors to be painted |
| Windows | | Number of windows to be painted |
| WallDescriptions | | Description for each wall; parameters are below |
| | Length | ft |
| | Height | ft |
| | PaintingType | Paint in new color, Refresh existing color |

As previously discussed, the system generates quotes in response to service requests submitted by consumers. Quotes can include a “state” property that describes the state of the quote. For example, quotes can be in one of the following states: “firm,” “tentative,” “order,” “being confirming,” “withdrawn,” “canceled order,” and “lost deal.” Quotes can change states based on “events” initiated or completed by the system, a consumer, or a service provider.

When a quote is first generated by the system, it can be a “firm” quote or a “tentative” quote. Firm quotes are typically quotes for relatively straightforward services such as an HVAC service call. Tentative quotes can be applied to more complex services such as HVAC installation. When a quote is a firm quote, the consumer can accept the quote, which changes the state of the quote from “firm” to “order,” and the consumer and service provider enter into a binding contract. If the quote is a tentative quote, the service provider may need to review the quote to confirm the quote. Once the service provider begins a review, the state of the quote changes from “tentative” to “being confirmed.”

The service provider can confirm the quote by reviewing any pictures or text provided by the consumer and any other available information to insure that the service request is properly and fully described by the consumer. If upon review, the service provider determines that the quoted price should be adjusted, the service provider can adjust the quoted price. Once the service provider completes the review, whether quoted price is adjusted or not, the quote typically changes state from “being confirmed” to “firm.” The consumer can then accept the quote, which changes the state from “firm” to “order.” If, during the review, the service provider determines that the service provider cannot complete the service requested for some reason, the service provider can withdraw the quote so that it cannot be accepted by a consumer, and the state of the quote changes from “being confirmed” to “withdrawn.”

The system can be arranged to allow for the consumer to cancel an order even after accepting the order. In this case, the state of the quote will change from “order” to “canceled order.” As described, the system can be designed to present all applicable quotes to a consumer submitting a service request. As will be appreciated, a consumer can be presented with many quotes in response to service request. Each of these quotes can be in a variety of states, including “firm,” “tentative,” “being confirmed,” or “withdrawn.” If the consumer orders one of the quotes presented, that quote will change to a state of “order,” while each other presented quote will change state to “lost deal.” If the consumer subsequently cancels the accepted quote, the system can be arranged so that other quotes previously presented to the consume change state from “lost deal” and revert back to its previous state.

TABLE 15
Quote States and Events

| | | Possible Events | | |
|---|---|---|---|---|
| Quote State | Description of | | New quote state | |
| Name | Quote State | Event name | (if changes) | Event description |
| Tentative | One of two possible | Get Firm Price | Quote Being | Consumer asks |
| Quote | initial states. | | Confirmed | provider to |
| | “Complex” | | | confirm his |
| | services, requiring | | | tentative quote |
| | provider's review of | | | |
| | quote (e.g. HVAC | | | |
| | Install), start in | | | |
| | this state | | | |
| | | Confirm Price | Firm Quote | Provider |
| | | | | confirms his |
| | | | | tentative quote |
| | | | | as is |
| | | Adjust Price | Firm Quote | Provider |
| | | | | confirms his |
| | | | | tentative quote |
| | | | | after adjusting |
| | | | | price |
| | | Withdraw | Withdrawn | Provider |
| | | Quote | Quote | withdraws his |
| | | | | tentative quote |
| | | Lose Deal | Lost Deal | Consumer |
| | | | | orders on a |
| | | | | different quote |
| | | | | on this request |
| | | Message | | Consumer sends |
| | | | | a message to |
| | | | | provider or vice |
| | | | | versa |
| Quote Being | Consumer asked | Confirm Price | Firm Quote | Provider |
| Confirmed | provider to confirm | | | confirms his |
| | his tentative quote, | | | tentative quote |
| | waiting for a firm | | | as is |
| | quote | | | |
| | | Adjust Price | Firm Quote | Provider |
| | | | | confirms his |
| | | | | tentative quote |
| | | | | after adjusting |
| | | | | price |
| | | Withdraw | Withdrawn | Provider |
| | | Quote | Quote | withdraws his |
| | | | | tentative quote |
| | | Lose Deal | Lost Deal | Consumer |
| | | | | orders on a |
| | | | | different quote |
| | | | | on this request |
| | | Message | | Consumer sends |
| | | | | a message to |
| | | | | provider or vice |
| | | | | versa |
| Firm Quote | One of two possible | Reduce Price | | Provider |
| | initial states. | | | reduces pricing |
| | “Simple” services | | | on his firm |
| | e.g. HVAC Service | | | quote |
| | Call start in this | | | |
| | state. Quotes for | | | |
| | “complex” services | | | |
| | come to this state | | | |
| | after confirmation | | | |
| | | Place Order | Order | Consumer |
| | | | | places an order |
| | | | | against a firm |
| | | | | quote |
| | | Lose Deal | Lost Deal | Consumer |
| | | | | orders on a |
| | | | | different quote |
| | | | | on this request |
| | | Message | | Consumer sends |
| | | | | a message to |
| | | | | provider or vice |
| | | | | versa |
| Order | Consumer ordered | Cancel Order | Cancelled | Consumer |
| | upon this quote | | Order | cancels his |
| | | | | order |
| | | Message | | Consumer sends |
| | | | | a message to |
| | | | | provider or vice |
| | | | | versa |
| Cancelled | Consumer ordered, | Message | | Consumer sends |
| Order | but then cancelled | | | a message to |
| | the order | | | provider or vice |
| | | | | versa |
| Withdrawn | Provider withdrew | | | |
| Quote | the quote | | | |
| Lost Deal | Consumer ordered | | | |
| | on a different quote | | | |
| | on this request | | | |

The service request fulfillment engine 102 can provide user interfaces for both consumers and service providers to manage quotes generated by the system. For example, when a consumer submits a service request, all quotes can be presented to the consumer in a user interface in a manner that allows the consumer to search and sort the quotes. The quotes can include an indication of the quote's state so that the consumer can accept firm quotes, ask that a tentative quote be confirm, or ask the service provider a question via the user interface or other mechanism. When a service provider accesses the system, a user interface can provide for the service provider to search and sort all quotes extended on the behalf of the service provider, including an indication of the state of each quote. The service provider can review tentative quotes and either confirm the quote, adjust the price of the quote, or withdraw the quote. The service provider can also answer any outstanding question from customers via the user interface or other mechanism.

The service request fulfillment engine 102 can be arranged so that any service provider can provide multiple or alternative quotes in response to service requests. In one example, a service provider can provide hardware of varying quality and functionality. For example, for an HVAC installation, a service provider can carry three levels of HVAC system—a relatively expensive premium product, a reasonably priced standard product, and a relatively inexpensive budget product. To the extent a consumer does not identify a particular price point or desired quality of hardware, the service provider can provide three quotes, one each for the premium hardware, standard hardware and budget hardware. All three quotes can also be assembled into one document for review by a consumer.

In general, the detailed descriptions herein have been directed to home repair and improvement services, and specifically to services related to installation, repair, and maintenance of HVAC systems. However, it will be appreciated that the online marketplace described and illustrated herein can include any category of service required by consumers and offered by service providers. For example, within the category of home repair and improvement services, the online marketplace can generate quotes for any number as services, such as roofing and siding installation and repair services; flooring and carpeting installation services; painting and staining services; window and door replacement and installation services; cement and stamped concrete services; landscaping and sprinkler installation services; and so on. For other examples, outside of home repair and improvement services, the online marketplace can generate quotes for auto repair and maintenance services; information technology service; legal services; children's birthday parties; and so on.

The examples illustrated in FIGS. 5-26 are of internet-enabled webpages. However, the system and methods described herein can also be implemented using mobile applications or any other user interface that provides for consumers and service providers to interact with the online marketplace. Mobile applications developed for mobile computing devices such as smart phones and tablets can include all the functionality described and illustrated in FIGS. 5-26. It will be further appreciated that the online marketplace can be a platform that includes functionality, data and information that can be leveraged by third-party developers to design and develop applications (such as implementations of new local services to be listed on the marketplace) that leverage the functionality, data, and information of the online marketplace.

While example systems, methods, and so on, have been illustrated by describing examples, and while the examples have been described in considerable detail, it is not the intention to restrict or in any way limit the scope of the appended claims to such detail. It is simply not possible to describe every conceivable combination of components or methodologies for purposes of describing the systems, methods, and so on. With the benefit of this application, additional advantages and modifications will readily appear to those skilled in the art. The scope of the claimed embodiments is to be determined by the appended claims and their equivalents.

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computing device,” as used herein, refers to a laptop computer, a desktop computer, a smartphone, a personal digital assistant, a cellular telephone, a tablet computer, an eReader, or the like.

“Computer-readable medium,” as used herein, refers to a medium that participates in directly or indirectly providing signals, instructions, or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory, and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, Phase Change Memory, and other media from which a computer, a processor, or other electronic device can read. Signals used to propagate instructions or other software over a network, like the Internet, can be considered a “computer-readable medium.”

“Logic,” as used herein, includes but is not limited to hardware, firmware, software, or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Software,” as used herein, includes but is not limited to, one or more computer or processor instructions, i.e., machine readable instructions, that can be read, interpreted, compiled, or executed and that cause a computer, processor, or other electronic device to perform functions, actions, or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system, or other types of executable instructions. The form of software may depend, for example, on requirements of a desired application, the environment in which it runs, or the desires of a designer/programmer or the like. Computer-readable or executable instructions can be located in one logic or distributed between two or more communicating, co-operating, or parallel processing logics and, thus, can be loaded or executed in serial, parallel, massively parallel, and other manners. One form of software is an app, or an application that executes on a mobile computing device such as a mobile phone.

Suitable software for implementing the various components of the example systems and methods described herein may be produced using programming languages and tools like Haskell, Java, Java Script, Java.NET, ASP.NET, VB.NET, Cocoa, Pascal, C#, C++, C, CGI, Perl, Python, SQL, APIs, SDKs, assembly, firmware, microcode, or other languages and tools. Software, whether an entire system or a component of a system, may be embodied as an article of manufacture and maintained or provided as part of a computer-readable medium. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

What is claimed is:

1. A computer-implemented method for generating a plurality of quotes, comprising executing on one or more processor the steps of:
presenting questions associated with service request parameters of a type of service;
receiving input indicative of values for the service request parameters, wherein the values for the service request parameters are associated with a service request;
providing service listings upon memory, wherein each of the service listings is associated with a service provider, service provider rules for the service provider, and price parameters for the service provider;
comparing the values for the service request parameters with the service provider rules;
matching the service request to matching listings of the service listings based upon the service request parameters and the service provider rules that are compared; and
generating a quote for each of the matching listings of the service listings, wherein the quote is calculated using the price parameters associated with the matching listings of the service listings.

2. The method of claim 1, wherein each of the quotes is associated with a state, and wherein the state is firm, tentative, order, being confirming, withdrawn, canceled order, or lost deal.

3. The method of claim 2, comprising executing on the one or more processor the steps of:
presenting quote state objects that provide visual indicia corresponding to the state of the quotes.

4. The method of claim 2, comprising executing on the one or more processor the steps of:
receiving input that generates a state event for one of the quotes; and
changing the state of the quotes in response to the state event.

5. The method of claim 1, comprising executing on the one or more processor the steps of:
receiving authority to be bound to an agreement from the service provider, prior to generating the quotes.

6. The method of claim 1, comprising executing on the one or more processor the steps of:
presenting questions associated with service listing parameters; and
receiving input indicative of listing values for the service listing parameters, wherein the listing values for the service listing parameters are associated with the service listings.

7. The method of claim 1, wherein the quotes comprise pricing, a description of service, a start date, and a finish date.

8. The method of claim 1, wherein the price parameters adjust labor costs based upon volume.

9. The method of claim 1, wherein the quotes are calculated using parts costs stored in a parts cost database.

10. The method of claim 1, wherein the quotes are calculated using parts costs from a customized price list.

11. The method of claim 1, wherein the service request parameters comprise a parameter related to a geographic location for service performance.

12. The method of claim 1, wherein the matching listings are matched based upon the service request parameters related to geographic location, equipment type, performance of equipment, or a combination thereof.

13. The method of claim 1, wherein the quotes are presented as quote objects that each provide a quote summary.

14. The method of claim 13, wherein each of the quote objects comprise a third party review object that to provide visual indicia indicative of third party ratings associated with the service provider.

15. A computer-implemented method for presenting predefined quotes, comprising executing on one or more processor the steps of:
providing service listings upon memory, wherein each of the service listings is associated with a service provider, service provider rules for the service provider, and price parameters for the service provider;
providing standard values for service request parameters for a plurality of service types;
comparing the standard values for the service request parameters with the service provider rules;
generating predefined quotes for each of the service types, wherein the predefined quotes are calculated using the price parameters associated with the service listings;
present quote objects upon a display, wherein each of the quote objects is associated with one of the service types and provides a visual summary indicative of the predefined quotes of the one of the service types;
receive input with a selected one of the quote objects; and
present, upon the display, the predefined quotes of the one of the service types associated with the selected one of the quote objects.

16. The method of claim 15, comprising executing on the one or more processor the steps of:
receiving input indicative of a change in the service request parameters, after the predefined quotes are presented; and
modifying one or more of the predefined quotes based upon the change in the service request parameters.

17. The method of claim 15, comprising executing on the one or more processor the steps of:
receiving input with a predefined quote object associated with one of the predefined quotes;
dispatch a selected service provider associated with the predefined quotes to perform a service.

18. The method of claim 15, comprising executing on the one or more processor the steps of:
selecting the selected service provider based upon availability, proximity to a consumer, or both.

19. The method of claim 15, wherein the predefined quotes are filtered based upon proximity to a geographic region.

20. A system for generating quotes upon a webpage, the system comprising:
(a) one or more databases defining one or more service listings;
wherein the service listings are associated with a service provider, service provider rules for the service provider, and price parameters for the service provider;
wherein the one or more databases belongs to an online marketplace;
wherein the online marketplace and the service provider are third parties with respect to one another;
(b) a service provider server of the service provider, wherein the service provider server is communicatively coupled to the one or more databases and programmed to:
present a webpage comprising a quote control configured to receive input;
receive input with the quote control;
launch a quote widget upon the webpage responsive to the input;
present questions associated with service request parameters with the quote widget;
receive input indicative of values for the service request parameters with the quote widget;
access the service provider rule and the price parameters; and
present a quote with the quote widget such that the quote is determined based upon the values for the service request parameters, the service provider rule, and the price parameters.
